(19) United States
(12) Patent Application Publication
(10) Pub. No.: US 2026/0133217 A1
(43) Pub. Date: May 14, 2026

(54) Inertial Sensor Device

(71) Applicant: SEIKO EPSON CORPORATION, Tokyo (JP)

(72) Inventor: Shinichi MITSUNAGA, Shiojiri (JP)

(21) Appl. No.: 19/386,457

(22) Filed: Nov. 12, 2025

(30) Foreign Application Priority Data
Nov. 13, 2024 (JP) 2024-198071

(51) Int. Cl. G01P 15/02

(52) U.S. Cl. CPC G01P 15/02

(57) ABSTRACT

In an inertial sensor device, a first inertial measurement unit transmits a first signal output from a signal processor to a third inertial measurement unit, a second inertial measurement unit transmits a second signal output from a signal processor to the third inertial measurement unit, and a signal processor of the third inertial measurement unit performs a calculation on the first signal, the second signal, and a third signal that is an output signal of an inertial sensor of the third inertial measurement unit to output the result.

The present application is based on, and claims priority from JP Application Serial Number 2024-198071, filed November 13, 2024, the disclosure of which is hereby incorporated by reference herein in its entirety.

### BACKGROUND

### 1. Technical Field

The present disclosure relates to an inertial sensor device.

### 2. Related Art

JP-A-2023-106236 describes an inertial measurement system in which N inertial measurement devices each including a triaxial angular velocity sensor and a triaxial acceleration sensor are coupled in series to a host device, and one of the N inertial measurement devices averages data respectively sampled by the N inertial measurement devices and then transmits the result to the host device. According to the inertial measurement system described in JP-A-2023-106236, since one of the inertial measurement devices averages the data respectively sampled by the N inertial measurement devices, a noise component is reduced to 1/√N, and the load on the host device is reduced.

JP-A-2023-106236 is an example of the related art.

However, in the inertial measurement system described in JP-A-2023-106236, since the N inertial measurement devices are coupled in series to the host device, the processing time and the communication time increase in proportion to the number N of inertial measurement devices, and when one of the inertial measurement devices breaks down, all the inertial measurement devices coupled ahead of that inertial measurement device become unavailable, and the effect of reducing the noise component is significantly degraded.

### SUMMARY

An aspect of an inertial sensor device according to the present disclosure is an inertial sensor device to be coupled to an external device, the inertial sensor device including a plurality of inertial measurement units, wherein each of the plurality of inertial measurement units includes an inertial sensor, a signal processor configured to process an output signal of the inertial sensor, a first communication unit, and a second communication unit, the plurality of inertial measurement units includes a first inertial measurement unit, a second inertial measurement unit, a third inertial measurement unit, and a fourth inertial measurement unit, the first communication unit of the first inertial measurement unit and the first communication unit of the second inertial measurement unit are coupled to the second communication unit of the third inertial measurement unit, the first communication unit of the third inertial measurement unit is coupled to the second communication unit of the fourth inertial measurement unit, the first communication unit of the fourth inertial measurement unit is coupled to the external device, the first communication unit of the first inertial measurement unit transmits a first signal output from the signal processor of the first inertial measurement unit to the second communication unit of the third inertial measurement unit, the first communication unit of the second inertial measurement unit transmits, to the second communication unit of the third inertial measurement unit, a second signal output from the signal processor of the second inertial measurement unit, the signal processor of the third inertial measurement unit performs a calculation on the first signal, the second signal, and a third signal that is an output signal of the inertial sensor of the third inertial measurement unit to output a fourth signal, the first communication unit of the third inertial measurement unit transmits the fourth signal to the second communication unit of the fourth inertial measurement unit, the signal processor of the fourth inertial measurement unit performs a calculation on the fourth signal and a fifth signal that is an output signal of the inertial sensor of the fourth inertial measurement unit to output a sixth signal, and the first communication unit of the fourth inertial measurement unit transmits the sixth signal to the external device.

Another aspect of the inertial sensor device according to the present disclosure is an inertial sensor device to be coupled to an external device, the inertial sensor device including a plurality of inertial measurement units, wherein each of the plurality of inertial measurement units includes an inertial sensor, a signal processor configured to process an output signal of the inertial sensor, a first communication unit, and a second communication unit, the plurality of inertial measurement units includes a first inertial measurement unit, a second inertial measurement unit, and a third inertial measurement unit, the first communication unit of the first inertial measurement unit and the first communication unit of the second inertial measurement unit are coupled to the second communication unit of the third inertial measurement unit, the first communication unit of the third inertial measurement unit is coupled to the external device, the first communication unit of the first inertial measurement unit transmits a first signal output from the signal processor of the first inertial measurement unit to the second communication unit of the third inertial measurement unit, the first communication unit of the second inertial measurement unit transmits a second signal output from the signal processor of the second inertial measurement unit to the second communication unit of the third inertial measurement unit, the signal processor performs a calculation on the first signal, the second signal, and a third signal that is an output signal of the inertial sensor of the third inertial measurement unit to output a fourth signal, and the first communication unit of the third inertial measurement unit transmits the fourth signal to the external device.

### BRIEF DESCRIPTION OF THE DRAWINGS

FIG. 1 is a diagram showing an overall configuration of an inertial sensor device according to a first embodiment.

FIG. 2 is a diagram showing a configuration example of an inertial measurement unit in the first embodiment.

FIG. 3 is a flowchart showing an example of a procedure of an initial setting of the inertial measurement unit in the first embodiment.

FIG. 4 is a diagram showing an overall configuration of an inertial sensor device according to a second embodiment.

FIG. 5 is a flowchart showing an example of a procedure of an initial setting of an inertial measurement unit in the second embodiment.

FIG. 6 is a diagram showing a configuration example of an inertial measurement unit in a third embodiment.

### DESCRIPTION OF EMBODIMENTS

Some preferred embodiments of the present disclosure will hereinafter be described in detail using the drawings. Note that the embodiments described below do not unreasonably limit the content of the present disclosure set forth in the appended claims. Further, all the configurations to be described below are not necessarily essential elements of the present disclosure.

### 1. First Embodiment

### 1-1. Configuration of Inertial Sensor Device

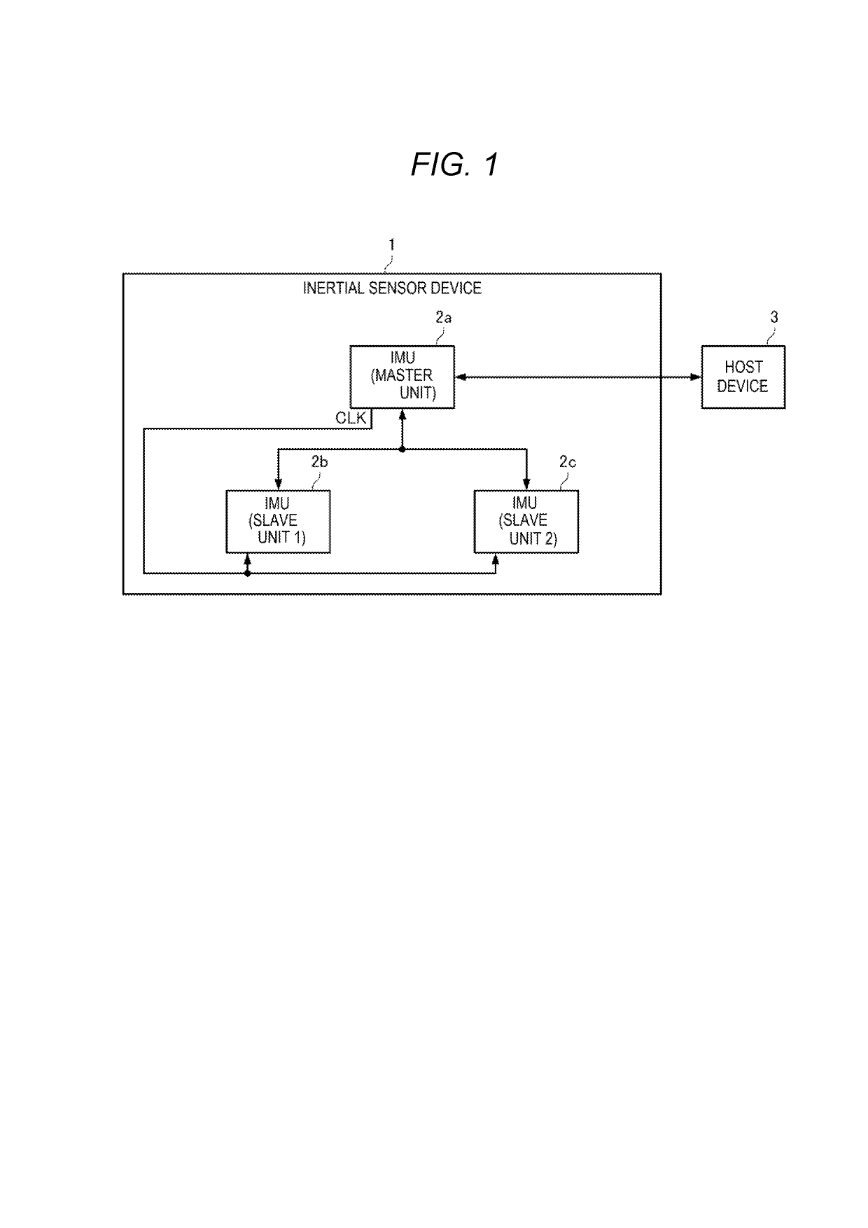

FIG. 1 is a diagram showing an overall configuration of an inertial sensor device according to a first embodiment. As shown in FIG. 1, an inertial sensor device 1 according to the first embodiment includes three inertial measurement units (IMUs) 2a, 2b, and 2c and is coupled to a host device 3 which is an external device.

Each of the IMUs 2a, 2b, and 2c includes an inertial sensor, and performs predetermined signal processing on data output from that inertial sensor to generate measurement data. The inertial sensors respectively provided to the IMUs 2a, 2b, and 2c detect physical quantities the same in type as each other. For example, each of the inertial sensors may detect uniaxial or multiaxial acceleration, may detect uniaxial or multiaxial angular velocity, or may detect triaxial acceleration and triaxial angular velocity. In the following description, it is assumed that each of the inertial sensors measures triaxial acceleration and triaxial angular velocity.

The IMU 2a is coupled to the host device 3 and can communicate with the host device 3. In the communication between the IMU 2a and the host device 3, the host device 3 serves as a master, and the IMU 2a serves as a slave. That is, the host device 3 transmits various commands to the IMU 2a, and the IMU 2a performs processing according to the commands received.

Further, the IMU 2a is coupled to the two IMUs 2b, 2c, and can communicate with each of the IMUs 2b, 2c. In the communication between the IMU 2a and each of the IMUs 2b, 2c, the IMU 2a serves as a master, and each of the IMUs 2b, 2c serves as a slave. That is, the IMU 2a transmits various commands to the IMUs 2b, 2c, and each of the IMUs 2b, 2c performs processing according to the commands received.

As described above, the IMU 2a functions as a "master unit" capable of communicating with the host device 3, and the other IMUs 2b, 2c function as "slave units". Hereinafter, the IMUs 2b, 2c are referred to as a "slave unit 1" and a "slave unit 2", respectively.

When the IMU 2a receives, from the host device 3, a sampling start command that requests transmission of measurement data, the IMU 2a samples data detected by its own inertial sensor and performs predetermined signal processing, and transmits the sampling start command to each of the IMUs 2b, 2c. Then, when each of the IMUs 2b, 2c receives the sampling start command from the IMU 2a, each of the IMUs 2b, 2c samples data detected by its own inertial sensor, performs predetermined signal processing, and transmits data obtained by that signal processing to the IMU 2a. The IMU 2a acquires the data from each of the IMUs 2b, 2c, and performs combining processing on the data acquired and the data obtained by its own predetermined signal processing. The combining processing may be, for example, averaging processing. Then, the IMU 2a transmits the measurement data obtained by the combining processing to the host device 3. The measurement data obtained by the combining processing includes measurement values of triaxial acceleration of an X axis, a Y axis, and a Z axis orthogonal to each other and measurement values of triaxial angular velocities of the X axis, the Y axis, and the Z axis.

The IMU 2a outputs, to the IMUs 2b, 2c, a clock signal CLK generated by an oscillation circuit incorporated therein. Each of the IMUs 2a, 2b, and 2c performs the signal processing in synchronization with the clock signal CLK. Therefore, by the IMUs 2a, 2b, and 2c sampling the output signals of the inertial sensors at the same edge of the clock signal CLK, the IMU 2a can synthesize three data measured at the same time by the respective IMUs 2a, 2b, and 2c.

### 1-2. Configuration of Inertial Measurement Unit (IMU)

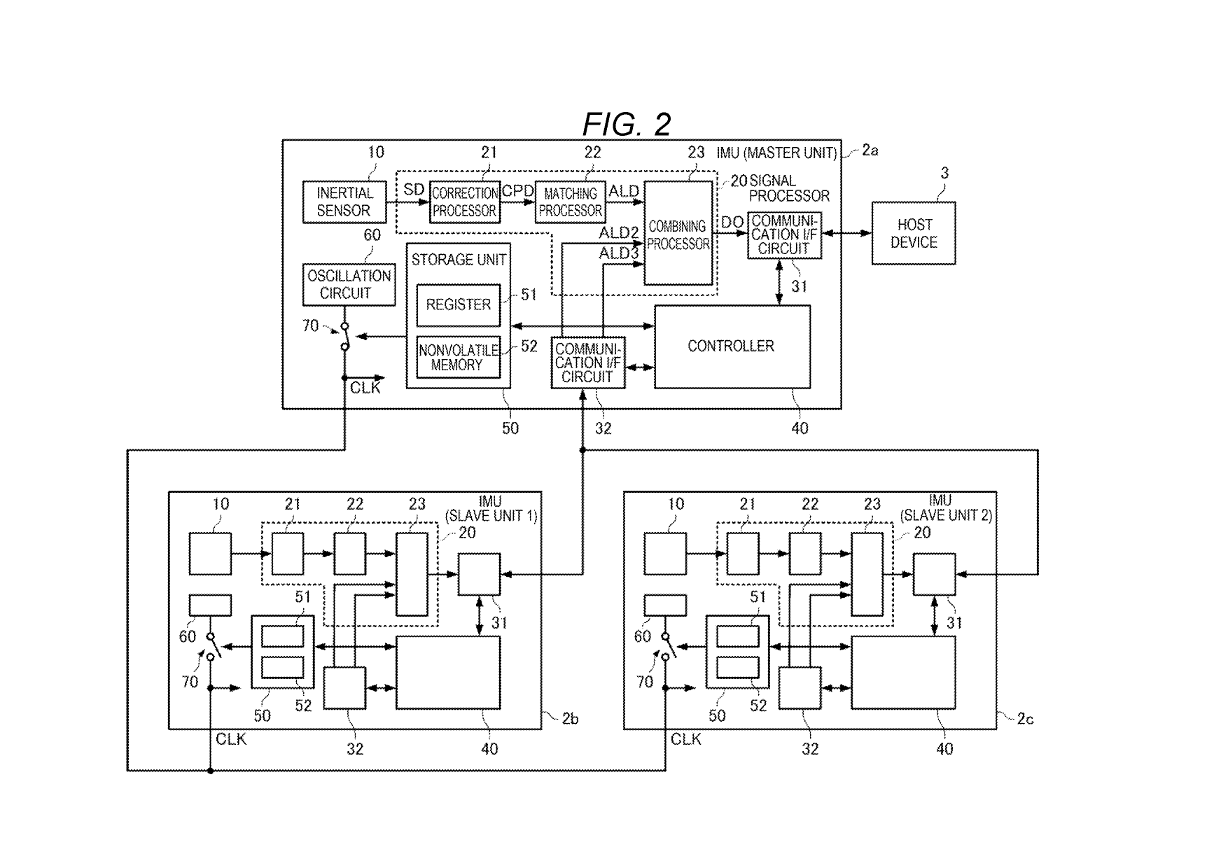

FIG. 2 is a diagram illustrating a configuration example of the IMUs 2a, 2b, and 2c. In the example in FIG. 2, the IMUs 2a, 2b, and 2c have the same configuration, and substantially the same elements are denoted by the same reference numeral in the IMUs 2a, 2b, and 2c. However, the IMUs 2a, 2b, and 2c are not required to be the same in configuration. Hereinafter, the configuration of the IMU 2a will be described in detail, and configurations of the IMUs 2b, 2c different from those of the IMU 2a will mainly be described.

As shown in FIG. 2, each of the IMUs 2a, 2b, and 2c includes an inertial sensor 10, a signal processor 20, communication interface circuits 31, 32, a controller 40, a storage unit 50, an oscillation circuit 60, and a switch 70.

The storage unit 50 includes a register 51 and a nonvolatile memory 52. Note that the storage unit 50 may include a RAM instead of the register 51, or may include the RAM together with the register 51. RAM is an abbreviation for Random Access Memory.

The oscillation circuit 60 of the IMU 2a performs an oscillation operation to output an oscillation signal. For example, the oscillation circuit 60 may be a crystal oscillation circuit that vibrates a quartz crystal resonator to output the oscillation signal. Since the quartz crystal resonator is high in Q-value and good in temperature characteristics, an oscillation signal small in frequency deviation can be obtained by using the crystal oscillation circuit as the oscillation circuit 60. In order to further reduce the frequency deviation of the oscillation signal, the oscillation circuit 60 may be a temperature-compensated crystal oscillation circuit.

The oscillation signal output from the oscillation circuit 60 is output as the clock signal CLK to the IMUs 2b, 2c via the switch 70 that is in an ON state. This clock signal CLK is also supplied to elements of the IMU 2a, and the elements of the IMU 2a operate in synchronization with the clock signal CLK. Meanwhile, in each of the IMUs 2b, 2c, the oscillation circuit 60 is set to stop the operation, and the switch 70 is set to an OFF state. Then, elements of the IMUs 2b, 2c operate in synchronization with the clock signal CLK supplied from the IMU 2a. Setting of ON and OFF states of the operation of the oscillation circuit 60 and setting of the ON and OFF states of the switch 70 in each of the IMUs 2a, 2b, and 2c are controlled in accordance with a setting value of the register 51 of the storage unit 50 in each of the IMUs 2a, 2b, and 2c.

The inertial sensor 10 is, for example, a 6Dof sensor, and measures triaxial acceleration and triaxial angular velocity. Dof is an abbreviation for Degrees Of Freedom. Specifically, the inertial sensor 10 detects triaxial acceleration in an x axis, a y axis, and a z axis and triaxial angular velocities in the x axis, the y axis, and the z axis. The inertial sensor 10 includes a temperature sensor (not shown), and outputs sensor data SD including measurement values of triaxial acceleration, measurement values of triaxial angular velocities, and a measurement value of the temperature. The sensor data SD is input to the signal processor 20. Note that the temperature sensor may be disposed outside the inertial sensor 10, and in this case, the sensor data SD in which data of a temperature detected by the temperature sensor is combined with data output from the inertial sensor 10 may be input to the signal processor 20.

The signal processor 20 processes the sensor data SD which is an output signal of the inertial sensor 10. As illustrated in FIG. 2, the signal processor 20 includes a correction processor 21, a matching processor 22, and a combining processor 23.

The correction processor 21 performs correction processing on the sensor data SD to output corrected data CPD. The correction processing includes processing such as bias correction, sensitivity correction, linearity correction, and temperature correction. Further, the correction processing may include processing of an orthogonality correction in which the triaxial acceleration and the triaxial angular velocities in the x axis, the y axis, and the z axis measured by the inertial sensor 10 are converted into triaxial acceleration and triaxial angular velocities in an x' axis, a y' axis, and a z' axis orthogonal to each other. Note that the orthogonality correction may be performed inside the inertial sensor 10. Various types of correction information used for the correction processing are generated in advance and are stored in the nonvolatile memory 52 of the storage unit 50. The corrected data CPD is input to the matching processor 22.

The matching processor 22 performs matching processing of detection axes of the inertial sensor 10 on the corrected data CPD to output matched data ALD. Specifically, the matching processing is processing in which the triaxial acceleration values and the triaxial angular velocity values in the x' axis, the y' axis, and the z' axis contained in the corrected data CPD are converted into the triaxial acceleration values in the X axis, the Y axis, and the Z axis of the inertial sensor device 1 and the triaxial angular velocity values in the X axis, the Y axis, and the Z axis. Matching information used for the matching processing is generated in advance and stored in the nonvolatile memory 52 of the storage unit 50. The matching information may be, for example, a rotation matrix for converting the three axes, that is, the x' axis, the y' axis, and the z' axis orthogonal to each other into the three axes, that is, the X axis, the Y axis, and the Z axis orthogonal to each other set in the inertial sensor device 1. The matched data ALD is input to the combining processor 23.

The combining processor 23 performs combining processing on the matched data ALD, and matched data ALD2, ALD3 acquired respectively from the IMUs 2b, 2c via the communication interface circuit 32 to output measurement data DO which is data having been combined. The combining processing may be, for example, averaging processing. Specifically, the combining processor 23 calculates average values of the respective acceleration values in the X axis, the Y axis, and the Z axis by adding the acceleration values in the X axis, the Y axis, and the Z axis contained in the matched data ALD, the acceleration values in the X axis, the Y axis, and the Z axis contained in the matched data ALD2, and the acceleration values in the X axis, the Y axis, and the Z axis contained in the matched data ALD3, and then dividing the result by 3. Similarly, the combining processor 23 calculates average values of the respective angular velocity values in the X axis, the Y axis, and the Z axis by adding the angular velocity values in the X axis, the Y axis, and the Z axis contained in the matched data ALD, the angular velocity values in the X axis, the Y axis, and the Z axis contained in the matched data ALD2, and the angular velocity values in the X axis, the Y axis, and the Z axis contained in the matched data ALD3, and then dividing the result by 3. Further, the combining processor 23 may calculate an average value of the temperature by adding the temperature value contained in the matched data ALD, the temperature value contained in the matched data ALD2, and the temperature value contained in the matched data ALD3 and then dividing the result by 3.

Note that since the communication interface circuit 32 of each of the IMUs 2b, 2c is coupled to no other IMUs, matched data of other IMUs are not input to the combining processor 23 of each of the IMUs 2b, 2c. Therefore, the combining processor 23 of each of the IMUs 2b, 2c outputs the matched data ALD as the measurement data DO.

The communication interface circuit 31 of the IMU 2a is a circuit that is coupled to the host device 3 and is used by the controller 40 of the IMU 2a to communicate with the host device 3, and receives various commands transmitted from the host device 3 and outputs the commands to the controller 40. The communication interface circuit 31 of the IMU 2b is a circuit that is coupled to the communication interface circuit 32 of the IMU 2a, and is used by the controller 40 of the IMU 2b to communicate with the controller 40 of the IMU 2a, and receives various commands transmitted from the IMU 2a and outputs the commands to the controller 40. The communication interface circuit 31 of the IMU 2c is a circuit that is coupled to the communication interface circuit 32 of the IMU 2a, and is used by the controller 40 of the IMU 2c to communicate with the controller 40 of the IMU 2a, and receives various commands transmitted from the IMU 2a and outputs the commands to the controller 40. The standard of communication performed via the communication interface circuits 31 of the IMUs 2a, 2b, and 2c may be, for example, UART, SPI, or other standards.

The controllers 40 of the IMUs 2a, 2b, and 2c interpret the commands received by the communication interface circuit 31 to perform processing according to the commands. For example, when the command received is a write command to the register 51 or the nonvolatile memory 52, the controller 40 performs processing of writing data contained in that command to the register 51 or the nonvolatile memory 52. Further, when the command received is a read command to the register 51 or the nonvolatile memory 52, the controller 40 reads data stored in the register 51 or the nonvolatile memory 52 and transmits the data thus read via the communication interface circuit 31. Further, when the command received is a command for requesting transmission of the measurement data DO, the controller 40 transmits, via the communication interface circuit 31, the measurement data DO output from the signal processor 20.

The communication interface circuit 32 of the IMU 2a is a circuit which is coupled to the communication interface circuits 31 of the respective IMUs 2b, 2c, and through which the controller 40 of the IMU 2a communicates with the controllers 40 of the respective IMUs 2b, 2c. The standard of communication performed via the communication interface circuit 32 of the IMU 2a may be, for example, UART, SPI, or other standards. The controller 40 of the IMU 2a generates various commands to each of the IMUs 2b, 2c, and transmits the commands thus generated to the communication interface circuit 31 of each of the IMUs 2b, 2c via the communication interface circuit 32.

For example, when the controller 40 of the IMU 2a receives a command for requesting transmission of the measurement data DO from the host device 3 via the communication interface circuit 31, the controller 40 of the IMU 2a transmits a command for requesting transmission of the measurement data DO to each of the communication interface circuits 31 of the IMUs 2b, 2c via the communication interface circuit 32.

In each of the IMUs 2b, 2c, the controller 40 receives the command via the communication interface circuit 31. Then, in the IMU 2b, under the control of the controller 40, the communication interface circuit 31 transmits, to the communication interface circuit 32 of the IMU 2a, the measurement data DO output from the signal processor 20. Similarly, in the IMU 2c, under the control of the controller 40, the communication interface circuit 31 transmits, to the communication interface circuit 32 of the IMU 2a, the measurement data DO output from the signal processor 20 of the IMU 2c.

Subsequently, in the IMU 2a, the controller 40 receives the measurement data DO from the IMU 2b via the communication interface circuit 32, and outputs the measurement data DO received as the matched data ALD2 to the combining processor 23 of the signal processor 20. Similarly, the controller 40 receives the measurement data DO from the IMU 2c via the communication interface circuit 32, and outputs the measurement data DO received as the matched data ALD3 to the combining processor 23 of the signal processor 20. Then, in the IMU 2a, the signal processor 20 performs a calculation on the matched data ALD2, ALD3 and the sensor data SD, which is the output signal of the inertial sensor 10, and then outputs the measurement data DO. That is, the signal processor 20 generates the matched data ALD based on the sensor data SD with the correction processor 21 and the matching processor 22, and outputs the measurement data DO obtained by performing the averaging processing on the matched data ALD, ALD2, and ALD3 with the combining processor 23. Then, the communication interface circuit 31 of the IMU 2a transmits, to the host device 3, the measurement data DO output from the signal processor 20.

Further, for example, when the controller 40 of the IMU 2a receives the write command to the register 51 or the nonvolatile memory 52 of the IMU 2b from the host device 3 via the communication interface circuit 31, the controller 40 of the IMU 2a transmits that command to the communication interface circuit 31 of the IMU 2b via the communication interface circuit 32. In the IMU 2b, the controller 40 receives that command via the communication interface circuit 31 and performs processing of writing data contained in that command to the register 51 or the nonvolatile memory 52. The same applies to processing of the IMUs 2a, 2c when the controller 40 of the IMU 2a receives the write command to the register 51 or the nonvolatile memory 52 of the IMU 2c from the host device 3 via the communication interface circuit 31.

Further, when the controller 40 of the IMU 2a receives the read command to the register 51 or the nonvolatile memory 52 of the IMU 2b from the host device 3 via the communication interface circuit 31, the controller 40 of the IMU 2a transmits that command to the communication interface circuit 31 of the IMU 2b via the communication interface circuit 32. In the IMU 2b, the controller 40 receives that command via the communication interface circuit 31, reads data stored in the register 51 or the nonvolatile memory 52, and then transmits the data thus read to the communication interface circuit 32 of the IMU 2a via the communication interface circuit 31. Subsequently, in the IMU 2a, the controller 40 receives data stored in the register 51 or the nonvolatile memory 52 of the IMU 2b via the communication interface circuit 32, and transmits the data thus received to the host device 3 via the communication interface circuit 31. The same applies to processing of the IMUs 2a, 2c when the controller 40 of the IMU 2b receives the read command to the register 51 or the nonvolatile memory 52 of the IMU 2c from the host device 3 via the communication interface circuit 31.

Note that each of the IMUs 2a, 2b, and 2c may function as the correction processor 21, the matching processor 22, the combining processor 23, and the controller 40 by a processor such as a CPU or a micro controller (not illustrated) executing a program stored in the nonvolatile memory 52.

### 1-3. Initial Setting of Inertial Sensor Device

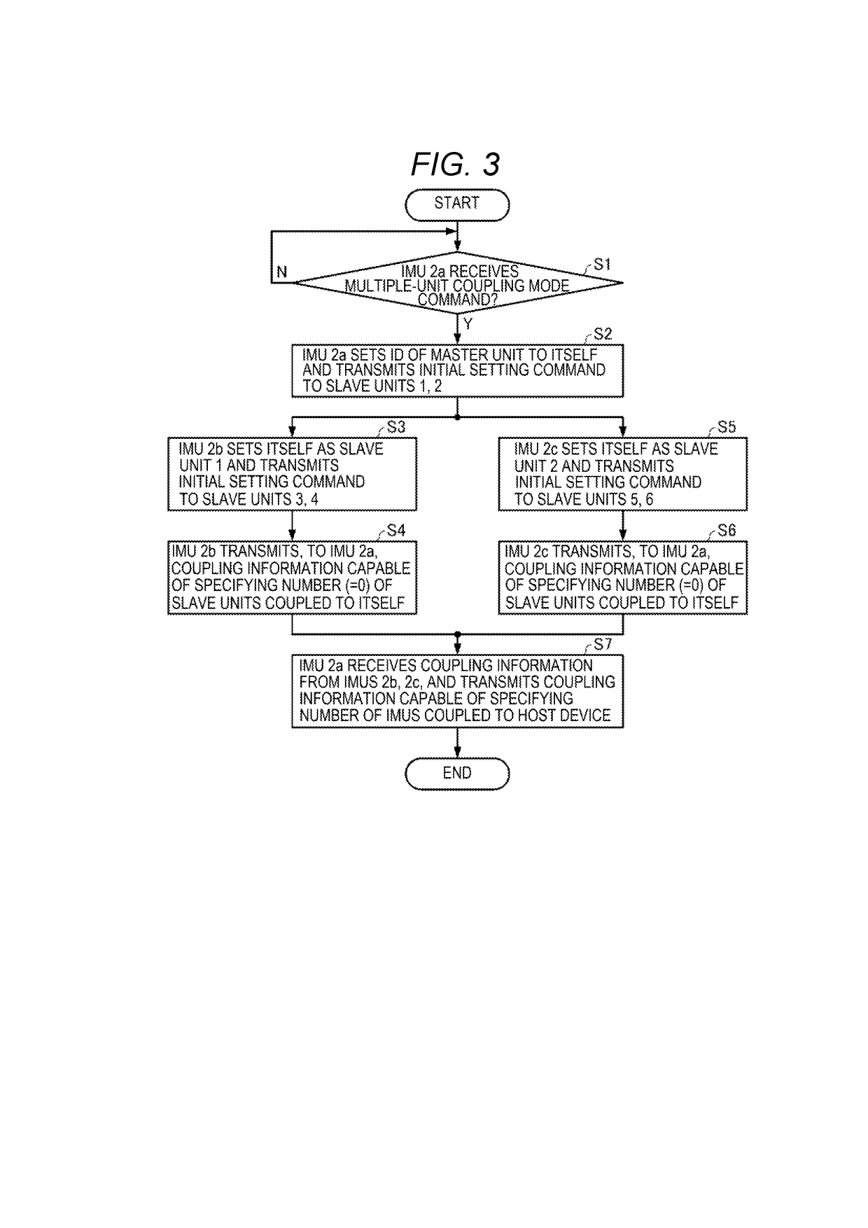

When receiving a multiple-unit coupling mode command from the host device 3, the inertial sensor device 1 performs initial setting of the IMUs 2a, 2b, and 2c. FIG. 3 is a flowchart illustrating an example of a procedure of initial setting of the IMUs 2a, 2b, and 2c in the first embodiment.

As shown in FIG. 3, when the IMU 2a receives a multiple-unit coupling mode command as an initial setting command from the host device 3 in step S1, first, in step S2, the IMU 2a sets an ID of the master unit to itself and transmits an initial setting command to the slave unit 1 and the slave unit 2.

The controller 40 of the IMU 2a recognizes that the IMU 2a itself is the master unit by receiving the multiple-unit coupling mode command from the host device 3, and sets the ID=0 of the master unit as its own ID in the register 51. In addition, since the IMU 2a itself is the master unit, the controller 40 of the IMU 2a assumes that the slave unit 1 and the slave unit 2 are coupled to the communication interface circuit 32, transmits the initial setting command including an ID of the slave unit 1 to the slave unit 1, and transmits the initial setting command including an ID of the slave unit 2 to the slave unit 2. The ID of the slave unit 1 is 1, and the ID of the slave unit 2 is 2. That is, there is created a relationship in which with respect to the ID=0 of the master unit, (the ID of the slave unit 1)=(the ID of the master unit)×2+1, and (the ID of the slave unit 2)=(the ID of the master unit)×2+2.

Actually, the IMU 2b as the slave unit 1 is coupled to the IMU 2a, and the IMU 2c as the slave unit 2 is coupled to the IMU 2a. Therefore, when the communication interface circuit 31 of the IMU 2a receives the multiple-unit coupling mode command from the host device 3, the communication interface circuit 32 of the IMU 2a transmits a command for performing the initial setting of the IMU 2b to the communication interface circuit 31 of the IMU 2b and transmits a command for performing the initial setting of the IMU 2c to the communication interface circuit 31 of the IMU 2c.

Then, in step S3, the IMU 2b receives the initial setting command, sets the IMU 2b itself as the slave unit 1, and transmits the initial setting command to slave units 3 and 4. Specifically, by receiving the initial setting command including the ID=1 of the slave unit 1 from the IMU 2a, the controller 40 of the IMU 2b recognizes that the IMU 2b itself is the slave unit 1, and sets the ID=1 of the slave unit 1 in the register 51 as the ID of itself. In addition, since the IMU 2b itself is the slave unit 1, the controller 40 of the IMU 2b assumes that the slave unit 3 and the slave unit 4 are coupled to the communication interface circuit 32, transmits the initial setting command including an ID of the slave unit 3 to the slave unit 3, and transmits the initial setting command including an ID of the slave unit 4 to the slave unit 4. The ID of the slave unit 3 is 3, and the ID of the slave unit 4 is 4. That is, there is created a relationship in which with respect to the ID=1 of the slave unit 1, (the ID of the slave unit 3)=(the ID of the slave unit 1)×2+1, and (the ID of the slave unit 4)=(the ID of the slave unit 1)×2+2.

Then, in step S4, the IMU 2b transmits, to the IMU 2a, coupling information capable of specifying the number of slave units coupled to the IMU 2b itself. Specifically, the controller 40 of the IMU 2b generates the coupling information capable of specifying the number of IMUs serving as slave units coupled to the communication interface circuit 32, and the communication interface circuit 31 of the IMU 2b transmits the coupling information to the communication interface circuit 32 of the IMU 2a. Since the slave unit 3 and the slave unit 4 are not coupled to the communication interface circuit 32 of the IMU 2b and therefore there is no response from the slave unit 3 and the slave unit 4 to the initial setting command, the IMU 2b transmits, to the IMU 2a, the coupling information representing that the number of slave units coupled is 0.

Similarly, in step S5, the IMU 2c receives the initial setting command, sets the IMU 2c itself as the slave unit 2, and transmits the initial setting command to a slave unit 5 and a slave unit 6. Specifically, by receiving the initial setting command including the ID=2 of the slave unit 2 from the IMU 2a, the controller 40 of the IMU 2c recognizes that the IMU 2c itself is the slave unit 2, and sets the ID=2 of the slave unit 2 in the register 51 as the ID of itself. In addition, since the IMU 2c itself is the slave unit 2, the controller 40 of the IMU 2c assumes that the slave unit 5 and the slave unit 6 are coupled to the communication interface circuit 32, transmits the initial setting command including an ID of the slave unit 5 to the slave unit 5, and transmits the initial setting command including an ID of the slave unit 6 to the slave unit 6. The ID of the slave unit 5 is 5, and the ID of the slave unit 6 is 6. That is, there is created a relationship in which with respect to the ID=2 of the slave unit 2, (the ID of the slave unit 5)=(the ID of the slave unit 2)×2+1, and (the ID of the slave unit 6)=(the ID of the slave unit 2)×2+2.

Then, in step S6, the IMU 2c transmits, to the IMU 2a, coupling information capable of specifying the number of slave units coupled to the IMU 2c itself. Specifically, the controller 40 of the IMU 2c generates the coupling information capable of specifying the number of IMUs serving as slave units coupled to the communication interface circuit 32, and the communication interface circuit 31 of the IMU 2c transmits the coupling information to the communication interface circuit 32 of the IMU 2a. Since the slave unit 5 and the slave unit 6 are not coupled to the communication interface circuit 32 of the IMU 2c and therefore there is no response from the slave unit 5 and the slave unit 6 to the initial setting command, the IMU 2c transmits, to the IMU 2a, the coupling information representing that the number of slave units coupled is 0.

Finally, in step S7, the IMU 2a receives the coupling information from each of the IMUs 2b, 2c, and transmits, to the host device 3, the coupling information capable of specifying the number of IMUs coupled to the host device 3. Specifically, the controller 40 of the IMU 2a generates the coupling information capable of specifying the number of IMUs coupled to the host device 3 based on the coupling information received from each of the IMUs 2b, 2c, and the communication interface circuit 31 of the IMU 2a transmits that coupling information to the host device 3. That is, the IMU 2a recognizes that three IMUs, that is, the IMU 2a itself and the IMUs 2b, 2c, are coupled to the host device 3, and transmits, to the host device 3, the coupling information representing that the number of units coupled is three.

Note that the signal processor 20 of the IMU 2a performs the calculation based on the coupling information generated by the controller 40. Specifically, the controller 40 stores, in the register 51, the coupling information representing that the number of units coupled is three. Then, the combining processor 23 adds each of the triaxial acceleration values, the triaxial angular velocity values, and the temperature values contained in the matched data ALD, ALD2, and ALD3, and then divides the result by the number of units coupled (=3) specified by the coupling information stored in the register 51 to thereby calculate the average values of the respective triaxial acceleration values, the triaxial angular velocity values, and the temperature values to generate the measurement data DO.

Note that in the first embodiment, the IMU 2b is an example of a "first inertial measurement unit", the IMU 2c is an example of a "second inertial measurement unit", and the IMU 2a is an example of a "third inertial measurement unit". Further, the communication interface circuit 31 is an example of a "first communication unit", and the communication interface circuit 32 is an example of a "second communication unit". Further, the measurement data DO output from the signal processor 20 of the IMU 2b is an example of a "first signal", and the measurement data DO output from the signal processor 20 of the IMU 2c is an example of a "second signal". Further, the sensor data SD, which is the output signal of the inertial sensor 10 of the IMU 2a, is an example of a "third signal", and the measurement data DO output from the signal processor 20 of the IMU 2a is an example of a "fourth signal". Further, the coupling information generated by the IMU 2b is an example of "first coupling information", the coupling information generated by the IMU 2c is an example of "second coupling information", and the coupling information generated by the IMU 2a is an example of "third coupling information".

### 1-4. Functions and Advantages

As described above, according to the inertial sensor device 1 of the first embodiment, since the IMU 2a performs the combining processing on the matched data ALD, ALD2, and ALD3 based on the output signals of the inertial sensors 10 of the respective IMUs 2a, 2b, and 2c to thereby generate the measurement data DO, it is possible to generate the measurement data DO in which random noise is reduced to 1/√3 and which is high in accuracy. Further, according to the inertial sensor device 1 of the first embodiment, since the IMUs 2b, 2c are coupled in parallel to the IMU 2a, an increase in processing time and communication time of the calculation is suppressed compared to when the IMUs 2b, 2c are coupled in series to the IMU 2a. In addition, when the IMUs 2b, 2c are supposedly coupled in series to the IMU 2a, when, for example, the IMU 2b breaks down, the IMUs 2b, 2c become unavailable, whereas according to the inertial sensor device 1 of the first embodiment, when the IMU 2b breaks down, only the IMU 2b becomes unavailable, and thus it is possible to suppress a decrease in calculation accuracy.

Further, according to the inertial sensor device 1 of the first embodiment, since each of the IMUs 2b, 2c transmits the coupling information to the IMU 2a, the IMU 2a can recognize the number of IMUs coupled to the host device 3 based on the coupling information of each of the IMU 2b and the IMU 2c and can perform appropriate combining processing. Further, in the inertial sensor device 1 according to the first embodiment, since the IMU 2a can recognize the number of IMUs coupled to the host device 3 by the communication of the IMUs 2a, 2b, and 2c, it is not necessary to store the coupling information in the nonvolatile memory 52 of the IMU 2a in advance. Therefore, according to the inertial sensor device 1 of the first embodiment, the production cost can be reduced, and it is possible to realize high expandability since it is easy to increase or decrease the number of IMUs.

Further, according to the inertial sensor device 1 of the first embodiment, since the host device 3 can recognize the number of IMUs coupled to itself based on the coupling information transmitted from the IMU 2a, the host device 3 can appropriately process the measurement data DO in accordance with the number of units coupled. Further, according to the inertial sensor device 1 of the first embodiment, since it is not necessary to store the coupling information in advance in the nonvolatile memory of the host device 3, it is possible to improve flexibility and expandability in a system construction.

Further, in the inertial sensor device 1 of the first embodiment, since the initial setting of the IMUs 2a, 2b, and 2c is performed by the multiple-unit coupling mode command transmitted from the host device 3, it is not necessary to store the initial setting information in advance in the nonvolatile memories 52 of the IMUs 2a, 2b, and 2c. Therefore, according to the inertial sensor device 1 of the first embodiment, the production cost can be reduced, and the flexibility and expandability of the system construction can be improved.

### 2. Second Embodiment

A second embodiment will hereinafter be described denoting substantially the same elements as those in the first embodiment by the same reference numerals, omitting or simplifying descriptions overlapping the descriptions in the first embodiment, and focusing attention on contents different from the contents of the first embodiment.

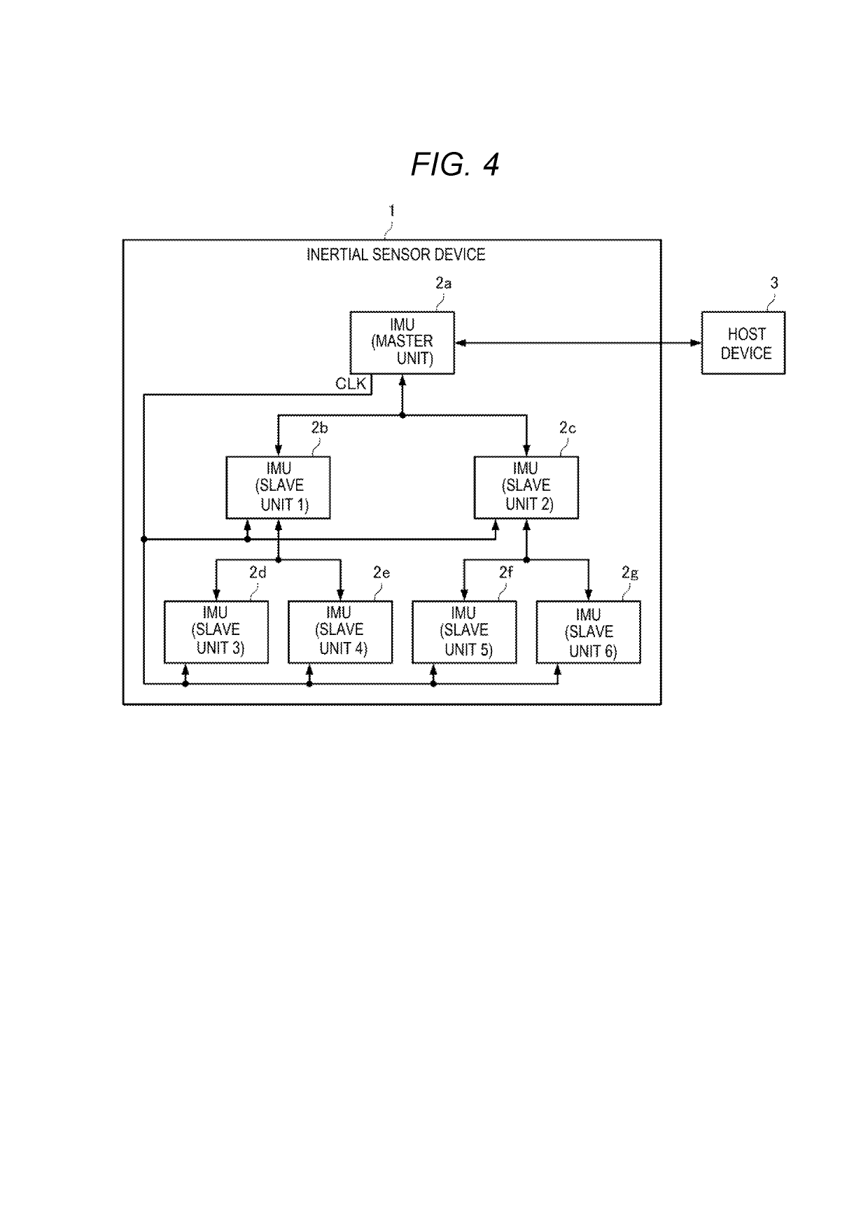

FIG. 4 is a diagram showing an overall configuration of an inertial sensor device 1 according to the second embodiment. As shown in FIG. 4, the inertial sensor device 1 according to the second embodiment includes seven IMUs 2a to 2g and is coupled to the host device 3 which is an external device.

Each of the IMUs 2a to 2g includes an inertial sensor, and performs predetermined signal processing on data output from that inertial sensor to generate measurement data. The inertial sensors respectively provided to the IMUs 2a to 2g detect physical quantities the same in type as each other. For example, each of the inertial sensors may detect uniaxial or multiaxial acceleration, may detect uniaxial or multiaxial angular velocity, or may detect triaxial acceleration and triaxial angular velocity. In the following description, it is assumed that each of the inertial sensors measures triaxial acceleration and triaxial angular velocity.

The IMU 2a is coupled to the host device 3 and can communicate with the host device 3. In the communication between the IMU 2a and the host device 3, the host device 3 serves as a master, and the IMU 2a serves as a slave. That is, the host device 3 transmits various commands to the IMU 2a, and the IMU 2a performs processing according to the commands received.

Further, the IMU 2a is coupled to the two IMUs 2b, 2c, and can communicate with each of the IMUs 2b, 2c. In the communication between the IMU 2a and each of the IMUs 2b, 2c, the IMU 2a serves as a master, and each of the IMUs 2b, 2c serves as a slave. That is, the IMU 2a transmits various commands to the IMUs 2b, 2c, and each of the IMUs 2b, 2c performs processing according to the commands received.

Further, the IMU 2b is coupled to the two IMUs 2d, 2e, and can communicate with each of the IMUs 2d, 2e. In the communication between the IMU 2b and each of the IMUs 2d, 2e, the IMU 2b serves as the master, and each of the IMUs 2d, 2e serves as the slave. That is, the IMU 2b transmits various commands to the IMUs 2d, 2e, and each of the IMUs 2d, 2e performs processing according to the commands received.

Further, the IMU 2c is coupled to the two IMUs 2f, 2g, and can communicate with each of the IMUs 2f, 2g. In the communication between the IMU 2c and each of the IMUs 2f, 2g, the IMU 2c serves as the master, and each of the IMUs 2f, 2g serves as the slave. That is, the IMU 2c transmits various commands to the IMUs 2f, 2g, and each of the IMUs 2f, 2g performs processing according to the commands received.

As described above, the IMU 2a functions as a "master unit" capable of communicating with the host device 3, and the other IMUs 2b to 2g function as "slave units”. Hereinafter, the IMUs 2b, 2c, 2d, 2e, 2f, and 2g are referred to as "slave unit 1”, "slave unit 2”, "slave unit 3”, "slave unit 4”, "slave unit 5”, and "slave unit 6”, respectively.

When the IMU 2a receives, from the host device 3, a sampling start command that requests transmission of measurement data, the IMU 2a samples data detected by its own inertial sensor and performs predetermined signal processing, and transmits the sampling start command to each of the IMUs 2b, 2c.

When the IMU 2b receives the sampling start command from the IMU 2a, the IMU 2b samples data detected by its own inertial sensor and performs predetermined signal processing, and transmits the sampling start command to each of the IMUs 2d, 2e.

When each of the IMUs 2d, 2e receives the sampling start command from the IMU 2b, each of the IMUs 2d, 2e samples data detected by its own inertial sensor, performs predetermined signal processing, and transmits measurement data of the triaxial acceleration and the triaxial angular velocities obtained by that signal processing to the IMU 2b. The IMU 2b acquires the measurement data from each of the IMUs 2d, 2e, and performs the combining processing on the measurement data thus obtained and the data of the triaxial acceleration and the triaxial angular velocities obtained by its own predetermined signal processing. The combining processing may be, for example, addition processing. Then, the IMU 2b transmits, to the IMU 2a, the measurement data including the measurement values of the triaxial acceleration and the measurement values of the triaxial angular velocities obtained by the combining processing.

When the IMU 2c receives the sampling start command from the IMU 2a, the IMU 2c samples data detected by its own inertial sensor and performs predetermined signal processing, and transmits the sampling start command to each of the IMUs 2f, 2g.

When each of the IMUs 2f, 2g receives the sampling start command from the IMU 2c, each of the IMUs 2f, 2g samples data detected by its own inertial sensor, performs predetermined signal processing, and transmits measurement data of the triaxial acceleration and the triaxial angular velocities obtained by that signal processing to the IMU 2c. The IMU 2c acquires the measurement data from each of the IMUs 2f, 2g, and performs the combining processing on the measurement data thus obtained and the data of the triaxial acceleration and the triaxial angular velocities obtained by its own predetermined signal processing. The combining processing may be, for example, addition processing. Then, the IMU 2c transmits, to the IMU 2a, the measurement data including the measurement values of the triaxial acceleration and the measurement values of the triaxial angular velocities obtained by the combining processing.

The IMU 2a acquires the measurement data from each of the IMUs 2b, 2c, and performs the combining processing on the measurement data thus obtained and the data of the triaxial acceleration and the triaxial angular velocities obtained by its own predetermined signal processing. The combining processing may be, for example, averaging processing. Then, the IMU 2a transmits, to the host device 3, the measurement data including the measurement values of the triaxial acceleration and the measurement values of the triaxial angular velocities obtained by the combining processing.

The IMU 2a outputs, to the IMUs 2b to 2g, a clock signal CLK generated by an oscillation circuit incorporated therein. Each of the IMUs 2a to 2g performs the signal processing in synchronization with the clock signal CLK. Therefore, by the IMUs 2a to 2g sampling the output signals of the inertial sensors at the same edge of the clock signal CLK, the IMU 2a can synthesize seven data measured at the same time by the respective IMUs 2a to 2g.

The IMUs 2a to 2g have the same configuration, and the configuration thereof is the same as that of the IMUs 2a, 2b, and 2c in the first embodiment shown in FIG. 2. That is, similarly to the IMUs 2a, 2b, and 2c in FIG. 2, the IMUs 2a to 2g each include the inertial sensor 10, the signal processor 20, the communication interface circuits 31, 32, the controller 40, the storage unit 50, the oscillation circuit 60, and the switch 70. The functions of the inertial sensor 10, the signal processor 20, the communication interface circuits 31, 32, the controller 40, the storage unit 50, and the oscillation circuit 60 are substantially the same as those in the first embodiment. Note that the IMUs 2a to 2g are not required to be the same in configuration.

In the second embodiment, the oscillation signal output from the oscillation circuit 60 is output as the clock signal CLK to the IMUs 2b to 2g via the switch 70 in the ON state. In each of the IMUs 2b to 2g, the oscillation circuit 60 is set to stop the operation, and the switch 70 is set to the OFF state. Further, the elements of the IMUs 2b to 2g operate in synchronization with the clock signal CLK supplied from the IMU 2a.

The combining processor 23 of the IMU 2a performs combining processing on the matched data ALD output from the matching processor 22 and the matched data ALD2, ALD3 respectively acquired from the IMUs 2b, 2c via the communication interface circuit 32, and outputs the measurement data DO which is data having been combined. The combining processor 23 of the IMU 2b performs combining processing on the matched data ALD output from the matching processor 22 and the matched data ALD2, ALD3 respectively acquired from the IMUs 2d, 2e via the communication interface circuit 32, and outputs the measurement data DO which is data having been combined. The combining processor 23 of the IMU 2c performs combining processing on the matched data ALD output from the matching processor 22 and the matched data ALD2, ALD3 respectively acquired from the IMUs 2f, 2g via the communication interface circuit 32, and outputs the measurement data DO which is data having been combined.

The combining processing performed by the combining processors 23 of the IMUs 2b, 2c may be, for example, addition processing. Specifically, the combining processor 23 calculates addition values of the respective acceleration values in the X axis, the Y axis, and the Z axis by adding the acceleration values in the X axis, the Y axis, and the Z axis contained in the matched data ALD, the acceleration values in the X axis, the Y axis, and the Z axis contained in the matched data ALD2, and the acceleration values in the X axis, the Y axis, and the Z axis contained in the matched data ALD3. Similarly, the combining processor 23 calculates addition values of the respective angular velocity values in the X axis, the Y axis, and the Z axis by adding the angular velocity values in the X axis, the Y axis, and the Z axis contained in the matched data ALD, the angular velocity values in the X axis, the Y axis, and the Z axis contained in the matched data ALD2, and the angular velocity values in the X axis, the Y axis, and the Z axis contained in the matched data ALD3. Further, the combining processor 23 may calculate an addition value of the temperature by adding the temperature value contained in the matched data ALD, the temperature value contained in the matched data ALD2, and the temperature value contained in the matched data ALD3.

Note that since the communication interface circuit 32 of each of the IMUs 2d, 2e, 2f, and 2g is coupled to no other IMUs, matched data of other IMUs are not input to the combining processor 23 of each of the IMUs 2d, 2e, 2f, and 2g. Therefore, the combining processor 23 of each of the IMUs 2d, 2e, 2f, and 2g outputs the matched data ALD as the measurement data DO.

The communication interface circuit 31 of the IMU 2a is coupled to the host device 3, receives various commands transmitted from the host device 3, and outputs the various commands to the controller 40. The communication interface circuit 31 of the IMU 2b is coupled to the communication interface circuit 32 of the IMU 2a, receives various commands transmitted from the IMU 2a, and outputs the various commands to the controller 40. The communication interface circuit 31 of the IMU 2c is coupled to the communication interface circuit 32 of the IMU 2a, receives various commands transmitted from the IMU 2a, and outputs the various commands to the controller 40.

The communication interface circuit 31 of the IMU 2d is coupled to the communication interface circuit 32 of the IMU 2b, receives various commands transmitted from the IMU 2b, and outputs the various commands to the controller 40. The communication interface circuit 31 of the IMU 2e is coupled to the communication interface circuit 32 of the IMU 2b, receives various commands transmitted from the IMU 2b, and outputs the various commands to the controller 40.

The communication interface circuit 31 of the IMU 2f is coupled to the communication interface circuit 32 of the IMU 2c, receives various commands transmitted from the IMU 2c, and outputs the various commands to the controller 40. The communication interface circuit 31 of the IMU 2g is coupled to the communication interface circuit 32 of the IMU 2c, receives various commands transmitted from the IMU 2c, and outputs the various commands to the controller 40.

The standard of communication performed via the communication interface circuits 31 of the IMUs 2a to 2g may be, for example, UART, SPI, or other standards.

The communication interface circuit 32 of the IMU 2a is coupled to each of the communication interface circuits 31 of the IMUs 2b, 2c, and the controller 40 of the IMU 2a generates various commands to each of the IMUs 2b, 2c and transmits the commands generated to each of the communication interface circuits 31 of the IMUs 2b, 2c via the communication interface circuit 32.

The communication interface circuit 32 of the IMU 2b is coupled to each of the communication interface circuits 31 of the IMUs 2d, 2e, and the controller 40 of the IMU 2b generates various commands to each of the IMUs 2d, 2e and transmits the commands generated to each of the communication interface circuits 31 of the IMUs 2d, 2e via the communication interface circuit 32.

The communication interface circuit 32 of the IMU 2c is coupled to each of the communication interface circuits 31 of the IMUs 2f, 2g, and the controller 40 of the IMU 2c generates various commands to each of the IMUs 2f, 2g and transmits the commands generated to each of the communication interface circuits 31 of the IMUs 2f, 2g via the communication interface circuit 32.

The standard of communication performed via the communication interface circuits 32 of the IMUs 2a, 2b, and 2c may be, for example, UART, SPI, or other standards.

For example, when the controller 40 of the IMU 2a receives a command for requesting transmission of the measurement data DO from the host device 3 via the communication interface circuit 31, the controller 40 of the IMU 2a transmits a command for requesting transmission of the measurement data DO to each of the communication interface circuits 31 of the IMUs 2b, 2c via the communication interface circuit 32.

In the IMU 2b, the controller 40 receives the command via the communication interface circuit 31, and transmits a command for requesting transmission of the measurement data DO to each of the communication interface circuits 31 of the IMUs 2d, 2e via the communication interface circuit 32. In each of the IMUs 2d, 2e, the controller 40 receives the command via the communication interface circuit 31. Then, in the IMU 2d, under the control of the controller 40, the communication interface circuit 31 transmits, to the communication interface circuit 32 of the IMU 2b, the measurement data DO output from the signal processor 20. Similarly, in the IMU 2e, under the control of the controller 40, the communication interface circuit 31 transmits, to the communication interface circuit 32 of the IMU 2b, the measurement data DO output from the signal processor 20.

Subsequently, in the IMU 2b, the controller 40 receives the measurement data DO from the IMU 2d via the communication interface circuit 32, and outputs the measurement data DO received as the matched data ALD2 to the combining processor 23 of the signal processor 20. Similarly, the controller 40 receives the measurement data DO from the IMU 2e via the communication interface circuit 32, and outputs the measurement data DO received as the matched data ALD3 to the combining processor 23 of the signal processor 20. Then, in the IMU 2b, the signal processor 20 performs a calculation on the matched data ALD2, ALD3 and the sensor data SD, which is the output signal of the inertial sensor 10, and then outputs the measurement data DO. That is, the signal processor 20 generates the matched data ALD based on the sensor data SD with the correction processor 21 and the matching processor 22, and outputs the measurement data DO obtained by performing the addition processing on the matched data ALD, ALD2, and ALD3 with the combining processor 23. The communication interface circuit 31 of the IMU 2b transmits the measurement data DO output from the signal processor 20 to the communication interface circuit 32 of the IMU 2a.

Further, in the IMU 2c, the controller 40 receives the command via the communication interface circuit 31, and transmits a command for requesting transmission of the measurement data DO to each of the communication interface circuits 31 of the IMUs 2f, 2g via the communication interface circuit 32. In each of the IMUs 2f, 2g, the controller 40 receives the command via the communication interface circuit 31. Then, in the IMU 2f, under the control of the controller 40, the communication interface circuit 31 transmits, to the communication interface circuit 32 of the IMU 2c, the measurement data DO output from the signal processor 20. Similarly, in the IMU 2g, under the control of the controller 40, the communication interface circuit 31 transmits, to the communication interface circuit 32 of the IMU 2c, the measurement data DO output from the signal processor 20.

Subsequently, in the IMU 2c, the controller 40 receives the measurement data DO from the IMU 2f via the communication interface circuit 32, and outputs the measurement data DO received as the matched data ALD2 to the combining processor 23 of the signal processor 20. Similarly, the controller 40 receives the measurement data DO from the IMU 2g via the communication interface circuit 32, and outputs the measurement data DO received as the matched data ALD3 to the combining processor 23 of the signal processor 20. Then, in the IMU 2c, the signal processor 20 performs a calculation on the matched data ALD2, ALD3 and the sensor data SD, which is the output signal of the inertial sensor 10, and then outputs the measurement data DO. That is, the signal processor 20 generates the matched data ALD based on the sensor data SD with the correction processor 21 and the matching processor 22, and outputs the measurement data DO obtained by performing the addition processing on the matched data ALD, ALD2, and ALD3 with the combining processor 23. The communication interface circuit 31 of the IMU 2c transmits the measurement data DO output from the signal processor 20 to the communication interface circuit 32 of the IMU 2a.

Subsequently, in the IMU 2a, the controller 40 receives the measurement data DO from the IMU 2b via the communication interface circuit 32, and outputs the measurement data DO received as the matched data ALD2 to the combining processor 23 of the signal processor 20. Similarly, the controller 40 receives the measurement data DO from the IMU 2c via the communication interface circuit 32, and outputs the measurement data DO received as the matched data ALD3 to the combining processor 23 of the signal processor 20. In the IMU 2a, the signal processor 20 performs a calculation on the matched data ALD2, ALD3 and the sensor data SD, which is the output signal of the inertial sensor 10, and then outputs the measurement data DO. That is, the signal processor 20 generates the matched data ALD based on the sensor data SD with the correction processor 21 and the matching processor 22, and outputs the measurement data DO obtained by performing the averaging processing on the matched data ALD, ALD2, and ALD3 with the combining processor 23. Then, the communication interface circuit 31 of the IMU 2a transmits, to the host device 3, the measurement data DO output from the signal processor 20.

Note that each of the IMUs 2a to 2g may function as the correction processor 21, the matching processor 22, the combining processor 23, and the controller 40 by a processor such as a CPU or a micro controller (not illustrated) executing a program stored in the nonvolatile memory 52.

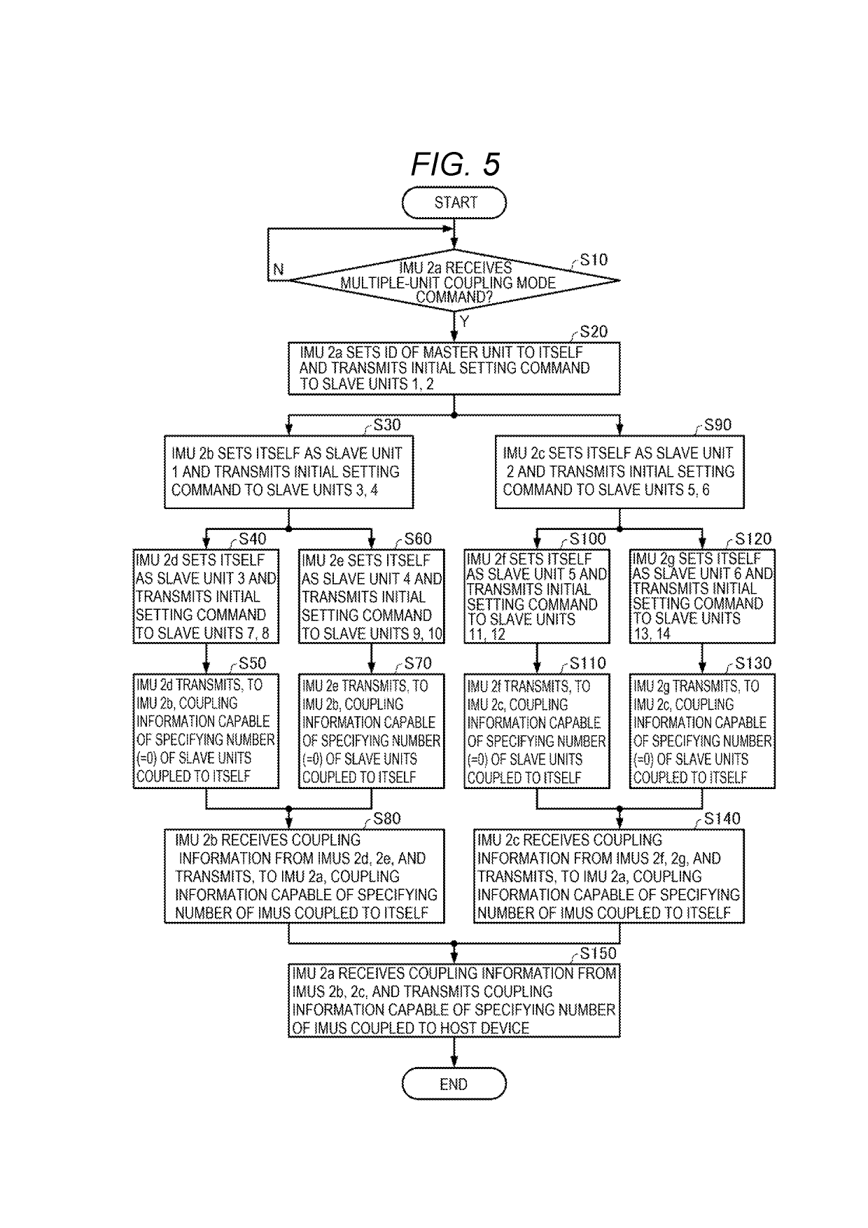

When receiving a multiple-unit coupling mode command from the host device 3, the inertial sensor device 1 performs initial setting of the IMUs 2a to 2g. FIG. 5 is a flowchart illustrating an example of a procedure of initial setting of the IMUs 2a to 2g in the second embodiment.

As shown in FIG. 5, when the IMU 2a receives a multiple-unit coupling mode command as an initial setting command from the host device 3 in step S10, first, in step S20, the IMU 2a sets an ID of the master unit to itself and transmits an initial setting command to the slave unit 1 and the slave unit 2.

The controller 40 of the IMU 2a recognizes that the IMU 2a itself is the master unit by receiving the multiple-unit coupling mode command from the host device 3, and sets the ID=0 of the master unit as its own ID in the register 51. In addition, since the IMU 2a itself is the master unit, the controller 40 of the IMU 2a assumes that the slave unit 1 and the slave unit 2 are coupled to the communication interface circuit 32, transmits the initial setting command including an ID of the slave unit 1 to the slave unit 1, and transmits the initial setting command including an ID of the slave unit 2 to the slave unit 2. The ID of the slave unit 1 is 1, and the ID of the slave unit 2 is 2. That is, there is created a relationship in which with respect to the ID=0 of the master unit, (the ID of the slave unit 1)=(the ID of the master unit)×2+1, and (the ID of the slave unit 2)=(the ID of the master unit)×2+2.

Actually, the IMU 2b as the slave unit 1 is coupled to the IMU 2a, and the IMU 2c as the slave unit 2 is coupled to the IMU 2a. Therefore, when the communication interface circuit 31 of the IMU 2a receives the multiple-unit coupling mode command from the host device 3, the communication interface circuit 32 of the IMU 2a transmits a command for performing the initial setting of the IMU 2b to the communication interface circuit 31 of the IMU 2b and transmits a command for performing the initial setting of the IMU 2c to the communication interface circuit 31 of the IMU 2c.

Then, in step S30, the IMU 2b receives the initial setting command, sets the IMU 2b itself as the slave unit 1, and transmits the initial setting command to slave units 3 and 4. Specifically, by receiving the initial setting command including the ID=1 of the slave unit 1 from the IMU 2a, the controller 40 of the IMU 2b recognizes that the IMU 2b itself is the slave unit 1, and sets the ID=1 of the slave unit 1 in the register 51 as the ID of itself. In addition, since the IMU 2b itself is the slave unit 1, the controller 40 of the IMU 2b assumes that the slave unit 3 and the slave unit 4 are coupled to the communication interface circuit 32, transmits the initial setting command including an ID of the slave unit 3 to the slave unit 3, and transmits the initial setting command including an ID of the slave unit 4 to the slave unit 4. The ID of the slave unit 3 is 3, and the ID of the slave unit 4 is 4. That is, there is created a relationship in which with respect to the ID=1 of the slave unit 1, (the ID of the slave unit 3)=(the ID of the slave unit 1)×2+1, and (the ID of the slave unit 4)=(the ID of the slave unit 1)×2+2.

Then, in step S40, the IMU 2d receives the initial setting command, sets the IMU 2d itself as the slave unit 3, and transmits the initial setting command to slave units 7 and 8. Specifically, by receiving the initial setting command including the ID=3 of the slave unit 3 from the IMU 2b, the controller 40 of the IMU 2d recognizes that the IMU 2d itself is the slave unit 3, and sets the ID=3 of the slave unit 3 in the register 51 as the ID of itself. In addition, since the IMU 2d itself is the slave unit 3, the controller 40 of the IMU 2d assumes that the slave unit 7 and the slave unit 8 are coupled to the communication interface circuit 32, transmits the initial setting command including an ID of the slave unit 7 to the slave unit 7, and transmits the initial setting command including an ID of the slave unit 8 to the slave unit 8. The ID of the slave unit 7 is 7, and the ID of the slave unit 8 is 8. That is, there is created a relationship in which with respect to the ID=3 of the slave unit 3, (the ID of the slave unit 7)=(the ID of the slave unit 3)×2+1, and (the ID of the slave unit 8)=(the ID of the slave unit 3)×2+2.

Then, in step S50, the IMU 2d transmits, to the IMU 2b, coupling information capable of specifying the number of slave units coupled to the IMU 2d itself. Specifically, the controller 40 of the IMU 2d generates the coupling information capable of specifying the number of IMUs serving as slave units coupled to the communication interface circuit 32, and the communication interface circuit 31 of the IMU 2d transmits the coupling information to the communication interface circuit 32 of the IMU 2b. Since the slave unit 7 and the slave unit 8 are not coupled to the communication interface circuit 32 of the IMU 2d and therefore there is no response from the slave unit 7 and the slave unit 8 to the initial setting command, the IMU 2d transmits, to the IMU 2b, the coupling information representing that the number of slave units coupled is 0.

Similarly, in step S60, the IMU 2e receives the initial setting command, sets the IMU 2e itself as the slave unit 4, and transmits the initial setting command to a slave unit 9 and a slave unit 10. Specifically, by receiving the initial setting command including the ID=4 of the slave unit 4 from the IMU 2b, the controller 40 of the IMU 2e recognizes that the IMU 2e itself is the slave unit 4, and sets the ID=4 of the slave unit 4 in the register 51 as the ID of itself. In addition, since the IMU 2e itself is the slave unit 4, the controller 40 of the IMU 2e assumes that the slave unit 9 and the slave unit 10 are coupled to the communication interface circuit 32, transmits the initial setting command including an ID of the slave unit 9 to the slave unit 9, and transmits the initial setting command including an ID of the slave unit 10 to the slave unit 10. The ID of the slave unit 9 is 9, and the ID of the slave unit 10 is 10. That is, there is created a relationship in which with respect to the ID=4 of the slave unit 4, (the ID of the slave unit 9)=(the ID of the slave unit 4)×2+1, and (the ID of the slave unit 10)=(the ID of the slave unit 4)×2+2.

Then, in step S70, the IMU 2e transmits, to the IMU 2b, coupling information capable of specifying the number of slave units coupled to the IMU 2e itself. Specifically, the controller 40 of the IMU 2e generates the coupling information capable of specifying the number of IMUs serving as slave units coupled to the communication interface circuit 32, and the communication interface circuit 31 of the IMU 2e transmits the coupling information to the communication interface circuit 32 of the IMU 2b. Since the slave unit 9 and the slave unit 10 are not coupled to the communication interface circuit 32 of the IMU 2e and therefore there is no response from the slave unit 9 and the slave unit 10 to the initial setting command, the IMU 2e transmits, to the IMU 2b, the coupling information representing that the number of slave units coupled is 0.

Then, in step S80, the IMU 2b receives the coupling information from the IMUs 2d, 2e, and transmits, to the IMU 2a, the coupling information capable of specifying the number of IMUs coupled to the IMU 2b itself. Specifically, the controller 40 of the IMU 2b generates the coupling information capable of specifying the number of IMUs coupled to the communication interface circuit 32 based on the coupling information received from the IMUs 2d, 2e, and the communication interface circuit 31 of the IMU 2b transmits the coupling information to the communication interface circuit 32 of the IMU 2a. The IMU 2b receives the coupling information representing that the number of slave units coupled is 0 from each of the IMUs 2d, 2e, and transmits, to the IMU 2a, the coupling information representing that the number of slave units coupled is 2.

Similarly, in step S90, the IMU 2c receives the initial setting command, sets the IMU 2c itself as the slave unit 2, and transmits the initial setting command to a slave unit 5 and a slave unit 6. Specifically, by receiving the initial setting command including the ID=2 of the slave unit 2 from the IMU 2a, the controller 40 of the IMU 2c recognizes that the IMU 2c itself is the slave unit 2, and sets the ID=2 of the slave unit 2 in the register 51 as the ID of itself. In addition, since the IMU 2c itself is the slave unit 2, the controller 40 of the IMU 2c assumes that the slave unit 5 and the slave unit 6 are coupled to the communication interface circuit 32, transmits the initial setting command including an ID of the slave unit 5 to the slave unit 5, and transmits the initial setting command including an ID of the slave unit 6 to the slave unit 6. The ID of the slave unit 5 is 5, and the ID of the slave unit 6 is 6. That is, there is created a relationship in which with respect to the ID=2 of the slave unit 2, (the ID of the slave unit 5)=(the ID of the slave unit 2)×2+1, and (the ID of the slave unit 6)=(the ID of the slave unit 2)×2+2.

Then, in step S100, the IMU 2f receives the initial setting command, sets the IMU 2f itself as the slave unit 5, and transmits the initial setting command to slave units 11 and 12. Specifically, by receiving the initial setting command including the ID=5 of the slave unit 5 from the IMU 2c, the controller 40 of the IMU 2f recognizes that the IMU 2f itself is the slave unit 5, and sets the ID=5 of the slave unit 5 in the register 51 as the ID of itself. In addition, since the IMU 2f itself is the slave unit 5, the controller 40 of the IMU 2f assumes that the slave unit 11 and the slave unit 12 are coupled to the communication interface circuit 32, transmits the initial setting command including an ID of the slave unit 11 to the slave unit 11, and transmits the initial setting command including an ID of the slave unit 12 to the slave unit 12. The ID of the slave unit 11 is 11, and the ID of the slave unit 12 is 12. That is, there is created a relationship in which with respect to the ID=5 of the slave unit 5, (the ID of the slave unit 11)=(the ID of the slave unit 5)×2+1, and (the ID of the slave unit 12)=(the ID of the slave unit 5)×2+2.

Then, in step S110, the IMU 2f transmits, to the IMU 2c, coupling information capable of specifying the number of slave units coupled to the IMU 2f itself. Specifically, the controller 40 of the IMU 2f generates the coupling information capable of specifying the number of IMUs serving as slave units coupled to the communication interface circuit 32, and the communication interface circuit 31 of the IMU 2f transmits the coupling information to the communication interface circuit 32 of the IMU 2c. Since the slave unit 11 and the slave unit 12 are not coupled to the communication interface circuit 32 of the IMU 2f and therefore there is no response from the slave unit 11 and the slave unit 12 to the initial setting command, the IMU 2f transmits, to the IMU 2c, the coupling information representing that the number of slave units coupled is 0.

Similarly, in step S120, the IMU 2g receives the initial setting command, sets the IMU 2g itself as the slave unit 6, and transmits the initial setting command to a slave unit 13 and a slave unit 14. Specifically, by receiving the initial setting command including the ID=6 of the slave unit 6 from the IMU 2c, the controller 40 of the IMU 2g recognizes that the IMU 2g itself is the slave unit 6, and sets the ID=6 of the slave unit 6 in the register 51 as the ID of itself. In addition, since the IMU 2g itself is the slave unit 6, the controller 40 of the IMU 2g assumes that the slave unit 13 and the slave unit 14 are coupled to the communication interface circuit 32, transmits the initial setting command including an ID of the slave unit 13 to the slave unit 13, and transmits the initial setting command including an ID of the slave unit 14 to the slave unit 14. The ID of the slave unit 13 is 13, and the ID of the slave unit 14 is 14. That is, there is created a relationship in which with respect to the ID=6 of the slave unit 6, (the ID of the slave unit 13)=(the ID of the slave unit 6)×2+1, and (the ID of the slave unit 14)=(the ID of the slave unit 6)×2+2.

Then, in step S130, the IMU 2g transmits, to the IMU 2c, coupling information capable of specifying the number of slave units coupled to the IMU 2g itself. Specifically, the controller 40 of the IMU 2g generates the coupling information capable of specifying the number of IMUs serving as slave units coupled to the communication interface circuit 32, and the communication interface circuit 31 of the IMU 2g transmits the coupling information to the communication interface circuit 32 of the IMU 2c. Since the slave unit 13 and the slave unit 14 are not coupled to the communication interface circuit 32 of the IMU 2g and therefore there is no response from the slave unit 13 and the slave unit 14 to the initial setting command, the IMU 2g transmits, to the IMU 2c, the coupling information representing that the number of slave units coupled is 0.

Then, in step S140, the IMU 2c receives the coupling information from the IMUs 2f, 2g, and transmits, to the IMU 2a, the coupling information capable of specifying the number of IMUs coupled to the IMU 2c itself. Specifically, the controller 40 of the IMU 2c generates the coupling information capable of specifying the number of IMUs coupled to the communication interface circuit 32 based on the coupling information received from the IMUs 2f, 2g, and the communication interface circuit 31 of the IMU 2c transmits the coupling information to the communication interface circuit 32 of the IMU 2a. The IMU 2c receives the coupling information representing that the number of slave units coupled is 0 from each of the IMUs 2f, 2g, and transmits, to the IMU 2a, the coupling information representing that the number of slave units coupled is 2.

Finally, in step S150, the IMU 2a receives the coupling information from each of the IMUs 2b, 2c, and transmits, to the host device 3, the coupling information capable of specifying the number of IMUs coupled to the host device 3. Specifically, the controller 40 of the IMU 2a generates the coupling information capable of specifying the number of IMUs coupled to the host device 3 based on the coupling information received from each of the IMUs 2b, 2c, and the communication interface circuit 31 of the IMU 2a transmits that coupling information to the host device 3. That is, the IMU 2a recognizes that seven IMUs, that is, the IMU 2a itself and the IMUs 2b to 2g, are coupled to the host device 3, and transmits, to the host device 3, the coupling information representing that the number of units coupled is seven.

Note that the signal processor 20 of the IMU 2a performs the calculation based on the coupling information generated by the controller 40. Specifically, the controller 40 stores, in the register 51, the coupling information representing that the number of units coupled is seven. Then, the combining processor 23 adds each of the triaxial acceleration values, the triaxial angular velocity values, and the temperature values contained in the matched data ALD, ALD2, and ALD3, and then divides the result by the number of units coupled (=7) specified by the coupling information stored in the register 51 to thereby calculate the average values of the respective triaxial acceleration values, the triaxial angular velocity values, and the temperature values to generate the measurement data DO.

Note that in the second embodiment, the IMU 2d is an example of a "first inertial measurement unit”, the IMU 2e is an example of a "second inertial measurement unit”, the IMU 2b is an example of a "third inertial measurement unit”, and the IMU 2a is an example of a "fourth inertial measurement unit”. Further, the IMU 2f is another example of the "first inertial measurement unit”, the IMU 2g is another example of the "second inertial measurement unit”, and the IMU 2c is another example of the "third inertial measurement unit”. Further, the communication interface circuit 31 is an example of a "first communication unit”, and the communication interface circuit 32 is an example of a "second communication unit”. Further, the measurement data DO output from the signal processor 20 of the IMU 2d is an example of a "first signal”, the measurement data DO output from the signal processor 20 of the IMU 2e is an example of a "second signal”, the sensor data SD which is the output signal of the inertial sensor 10 of the IMU 2b is an example of a "third signal”, and the measurement data DO output from the signal processor 20 of the IMU 2b is an example of a "fourth signal”. Further, the measurement data DO output from the signal processor 20 of the IMU 2f is another example of the "first signal”, the measurement data DO output from the signal processor 20 of the IMU 2g is another example of the "second signal”, the sensor data SD that is the output signal of the inertial sensor 10 of the IMU 2c is another example of the "third signal”, and the measurement data DO output from the signal processor 20 of the IMU 2c is another example of the "fourth signal”. Further, the sensor data SD, which is the output signal of the inertial sensor 10 of the IMU 2a, is an example of a "fifth signal”, and the measurement data DO output from the signal processor 20 of the IMU 2a is an example of a "sixth signal”. Further, the coupling information generated by the IMU 2d is an example of "first coupling information”, the coupling information generated by the IMU 2e is an example of "second coupling information”, the coupling information generated by the IMU 2b is an example of "third coupling information”, and the coupling information generated by the IMU 2a is an example of "fourth coupling information”. Further, the coupling information generated by the IMU 2f is another example of the "first coupling information”, the coupling information generated by the IMU 2g is another example of the "second coupling information”, and the coupling information generated by the IMU 2c is another example of the "third coupling information”.

As described above, according to the inertial sensor device 1 of the second embodiment, since the IMU 2a performs the combining processing on the matched data ALD, ALD2, and ALD3 based on the output signals of the inertial sensors 10 of the respective IMUs 2a to 2g to thereby generate the measurement data DO, it is possible to generate the measurement data DO in which random noise is reduced to 1/√7 and which is high in accuracy. Further, according to the inertial sensor device 1 of the second embodiment, since the IMUs 2b, 2c are coupled in parallel to the IMU 2a, the IMUs 2d, 2e are coupled in parallel to the IMU 2b, and the IMUs 2f, 2g are coupled in parallel to the IMU 2c, an increase in processing time and communication time of the calculation is suppressed compared to when the IMUs 2b to 2g are coupled in series to the IMU 2a. In addition, when the IMUs 2b to 2g are supposedly coupled in series to the IMU 2a, when, for example, the IMU 2b breaks down, the IMUs 2b to 2g become unavailable, whereas according to the inertial sensor device 1 of the second embodiment, when the IMU 2b breaks down, only the IMUs 2b, 2d, and 2e become unavailable, and thus it is possible to suppress a decrease in calculation accuracy.

Further, according to the inertial sensor device 1 of the second embodiment, since the IMUs 2d, 2e each transmit the coupling information to the IMU 2b, the IMUs 2f, 2g each transmit the coupling information to the IMU 2c, the IMU 2b transmits the coupling information generated based on the coupling information of the IMUs 2d, 2e to the IMU 2a, and the IMU 2c transmits the coupling information generated based on the coupling information of the IMUs 2f, 2g to the IMU 2a, the IMU 2a can recognize the number of IMUs coupled to the host device 3 based on the coupling information of the IMUs 2b, 2c to perform appropriate combining processing. Further, in the inertial sensor device 1 according to the second embodiment, since the IMU 2a can recognize the number of IMUs coupled to the host device 3 by the communication of the IMUs 2a to 2g, it is not necessary to store the coupling information in the nonvolatile memory 52 of the IMU 2a in advance. Therefore, according to the inertial sensor device 1 of the second embodiment, the production cost can be reduced, and it is possible to realize high expandability since it is easy to increase or decrease the number of IMUs.

Further, according to the inertial sensor device 1 of the second embodiment, since the host device 3 can recognize the number of IMUs coupled to itself based on the coupling information transmitted from the IMU 2a, the host device 3 can appropriately process the measurement data DO in accordance with the number of units coupled. Further, according to the inertial sensor device 1 of the second embodiment, since it is not necessary to store the coupling information in advance in the nonvolatile memory of the host device 3, it is possible to improve flexibility and expandability in a system construction.

Further, in the inertial sensor device 1 of the second embodiment, since the initial setting of the IMUs 2a to 2g is performed by the multiple-unit coupling mode command transmitted from the host device 3, it is not necessary to store the initial setting information in advance in the nonvolatile memories 52 of the IMUs 2a to 2g. Therefore, according to the inertial sensor device 1 of the second embodiment, the production cost can be reduced, and the flexibility and expandability of the system construction can be improved.

### 3. Third Embodiment

Hereinafter, regarding a third embodiment, the same component elements as those of the first embodiment or the second embodiment have the same signs, the overlapping description with the first embodiment or the second embodiment will be omitted or simplified, and differences from the first embodiment or the second embodiment will be mainly described.

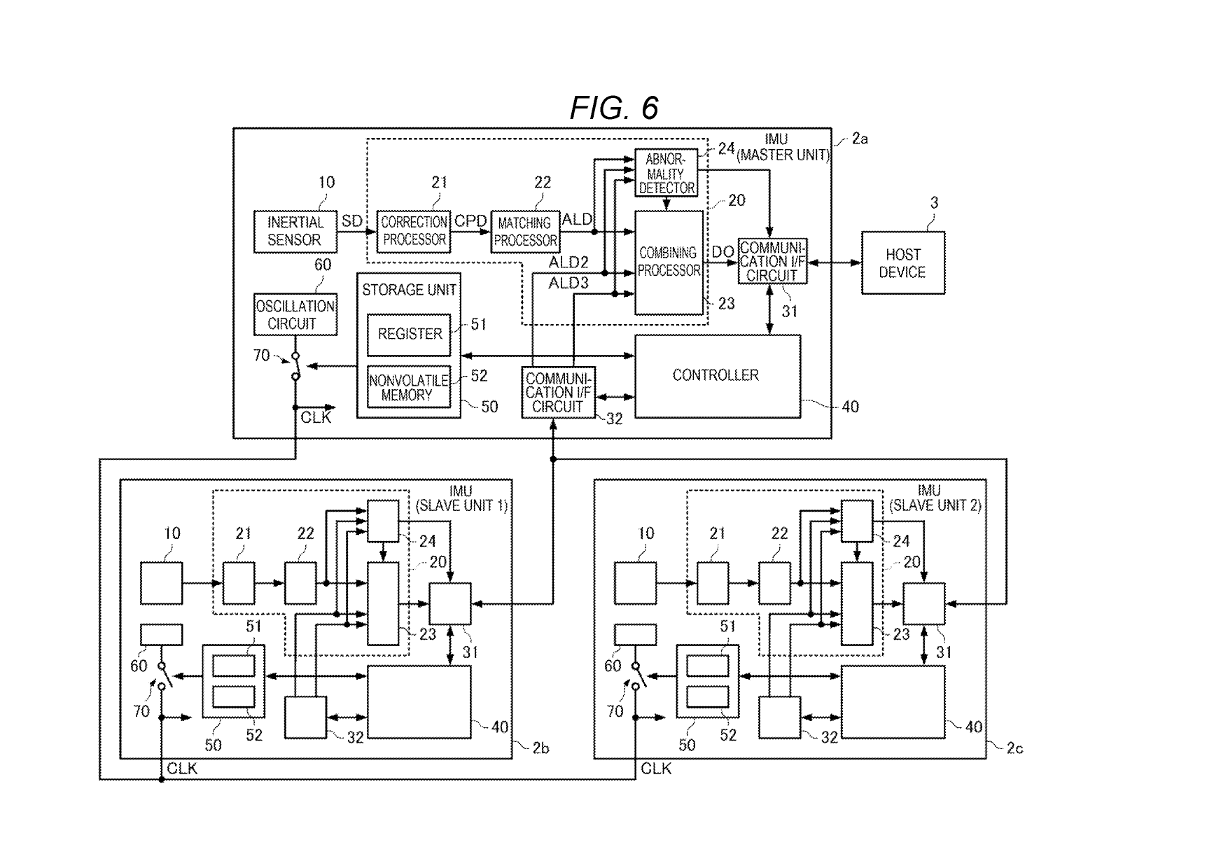

Since the overall configuration of the inertial sensor device 1 according to the third embodiment is the same as that in FIG. 1, the illustration thereof will be omitted. FIG. 6 is a diagram showing a configuration example of the IMUs 2a, 2b, and 2c provided to the inertial sensor device 1 of the third embodiment. The IMUs 2a, 2b, and 2c in the third embodiment are different from the IMUs 2a, 2b, and 2c in the first embodiment shown in FIG. 2 in that the signal processor 20 includes an abnormality detector 24 in addition to the correction processor 21, the matching processor 22, and the combining processor 23.

The abnormality detector 24 provided to the signal processor 20 of the IMU 2a determines whether the matched data ALD generated by performing predetermined processing, that is, the correction processing and the matching processing on the matched data ALD2 output from the signal processor 20 of the IMU 2b, the matched data ALD3 output from the signal processor 20 of the IMU 2c, and the output signal of the inertial sensor 10 of the IMU 2a is normal or abnormal. Note that the matched data ALD of the IMU 2a is an example of a "fifth signal”.

Specifically, the abnormality detector 24 of the IMU 2a determines whether each of the measurement values of the triaxial acceleration, the measurement values of the triaxial angular velocities, and the measurement values of the temperature contained in the matched data ALD, ALD2, and ALD3 is normal or abnormal. For example, when a difference between the measurement value of the X-axis acceleration contained in the matched data ALD and the measurement value of the X-axis acceleration contained in the matched data ALD2 is smaller than a first threshold value, a difference between the measurement value of the X-axis acceleration contained in the matched data ALD and the measurement value of the X-axis acceleration contained in the matched data ALD3 is larger than a second threshold value equal to or larger than the first threshold value, and a difference between the measurement value of the X-axis acceleration contained in the matched data ALD2 and the measurement value of the X-axis acceleration contained in the matched data ALD3 is larger than the second threshold value, the abnormality detector 24 may determine that the measurement value of the X-axis acceleration contained in each of the matched data ALD and ALD2 is normal and the measurement value of the X-axis acceleration contained in the matched data ALD3 is abnormal. Further, for example, the abnormality detector 24 may determine that the measurement value of the X-axis acceleration contained in the matched data ALD3 is abnormal when the measurement value of the X-axis acceleration contained in the matched data ALD3 does not change in a period in which the measurement value of the X-axis acceleration contained in each of the matched data ALD, ALD2 changes.

Then, the abnormality detector 24 outputs, to the combining processor 23, determination information representing whether each of the measurement values of the triaxial acceleration, the measurement values of the triaxial angular velocities, and the measurement values of the temperature contained in the matched data ALD, ALD2, and ALD3 is normal or abnormal.

The combining processor 23 of the IMU 2a performs the combining processing using the data that is determined to be normal out of the matched data ALD, ALD2, and ALD3 based on the determination information output from the abnormality detector 24. Then, the combining processor 23 outputs the measurement data DO obtained by adding combined-item number information capable of specifying the number of data used in the combining processing to the data generated by the combining processing. Specifically, the combining processor 23 performs the combining processing using the measurement values that are determined to be normal out of the measurement values of the triaxial acceleration, the measurement values of the triaxial angular velocities, and the measurement values of the temperature contained in the matched data ALD, ALD2, and ALD3. Then, the combining processor 23 outputs the measurement data DO obtained by adding the combined-item number information that includes the number of measurement values used in the combining processing for each of the measurement values of the triaxial acceleration, the measurement values of the triaxial angular velocities, and the measurement values of the temperature to the data generated by the combining processing. For example, when it is determined that the measurement value of the X-axis acceleration contained in each of the matched data ALD and ALD2 is normal and the measurement value of the X-axis acceleration contained in the matched data ALD3 is abnormal, the combining processor 23 adds the measurement values of the X-axis acceleration contained in the matched data ALD, ALD2, which are normal, and then divides the result by 2, which is the number of normal data, to thereby calculate the average value of the X-axis acceleration. Then, the combining processor 23 outputs the measurement data DO obtained by adding the combined-item number information including the number (=2) of the measurement values of the triaxial acceleration used in the combining processing to the data generated by the combining processing.

Then, the communication interface circuit 31 of the IMU 2a transmits the measurement data DO in which the combined-item number information is added, and which is output from the signal processor 20, to the host device 3 under the control of the controller 40.

Note that in the overall configuration of the inertial sensor device 1 according to the third embodiment, the seven IMUs 2a to 2g may be coupled similarly to FIG. 4. In this case, the IMUs 2a to 2g have the same configuration, and the configuration is the same as that of the IMUs 2a, 2b, and 2c illustrated in FIG. 6. Note that the IMUs 2a to 2g are not required to be the same in configuration.

The abnormality detector 24 provided to the signal processor 20 of the IMU 2b determines whether the matched data ALD generated by performing predetermined processing, that is, the correction processing and the matching processing on the matched data ALD2 output from the signal processor 20 of the IMU 2d, the matched data ALD3 output from the signal processor 20 of the IMU 2e, and the output signal of the inertial sensor 10 of the IMU 2b is normal or abnormal. Note that the matched data ALD of the IMU 2a is an example of a "seventh signal”.

Specifically, the abnormality detector 24 of the IMU 2b determines whether each of the measurement values of the triaxial acceleration, the measurement values of the triaxial angular velocities, and the measurement values of the temperature contained in the matched data ALD, ALD2, and ALD3 is normal or abnormal, and then outputs the determination information representing the determination result to the combining processor 23.

The combining processor 23 of the IMU 2b performs the combining processing using the data which are determined to be normal out of the matched data ALD, ALD2, and ALD3 based on the determination information output from the abnormality detector 24, and then outputs the measurement data DO obtained by adding the combined-item number information capable of specifying the number of data used for the combining processing to the data generated by the combining processing. Then, the communication interface circuit 31 of the IMU 2b transmits, to the communication interface circuit 32 of the IMU 2a, the measurement data DO in which the combined-item number information is added, and which is output from the signal processor 20, under the control of the controller 40.

Similarly, the abnormality detector 24 provided to the signal processor 20 of the IMU 2c determines whether the matched data ALD generated by performing predetermined processing, that is, the correction processing and the matching processing on the matched data ALD2 output from the signal processor 20 of the IMU 2f, the matched data ALD3 output from the signal processor 20 of the IMU 2g, and the output signal of the inertial sensor 10 of the IMU 2c is normal or abnormal. Specifically, the abnormality detector 24 of the IMU 2c determines whether each of the measurement values of the triaxial acceleration, the measurement values of the triaxial angular velocities, and the measurement values of the temperature contained in the matched data ALD, ALD2, and ALD3 is normal or abnormal, and then outputs the determination information representing the determination result to the combining processor 23.

The combining processor 23 of the IMU 2c performs the combining processing using the data which are determined to be normal out of the matched data ALD, ALD2, and ALD3 based on the determination information output from the abnormality detector 24, and then outputs the measurement data DO obtained by adding the combined-item number information capable of specifying the number of data used for the combining processing to the data generated by the combining processing. Then, the communication interface circuit 31 of the IMU 2c transmits, to the communication interface circuit 32 of the IMU 2a, the measurement data DO in which the combined-item number information is added, and which is output from the signal processor 20, under the control of the controller 40.

The abnormality detector 24 provided to the signal processor 20 of the IMU 2a determines whether the matched data ALD generated by performing predetermined processing, that is, the correction processing and the matching processing on the matched data ALD2 output from the signal processor 20 of the IMU 2b, the matched data ALD3 output from the signal processor 20 of the IMU 2c, and the output signal of the inertial sensor 10 of the IMU 2a is normal or abnormal. Specifically, the abnormality detector 24 of the IMU 2a determines whether each of the measurement values of the triaxial acceleration, the measurement values of the triaxial angular velocities, and the measurement values of the temperature contained in the matched data ALD, ALD2, and ALD3 is normal or abnormal, and then outputs the determination information representing the determination result to the combining processor 23.

The combining processor 23 of the IMU 2a performs the combining processing using the data which are determined to be normal out of the matched data ALD, ALD2, and ALD3 based on the determination information output from the abnormality detector 24, and then outputs the measurement data DO obtained by adding the combined-item number information capable of specifying the number of data used for the combining processing to the data generated by the combining processing. Then, the communication interface circuit 31 of the IMU 2a transmits the measurement data DO in which the combined-item number information is added, and which is output from the signal processor 20, to the host device 3 under the control of the controller 40.

For example, it is assumed when the abnormality detector 24 of the IMU 2b determines that the measurement value of the X-axis acceleration contained in the matched data ALD3 output from the communication interface circuit 31 of the IMU 2e is abnormal, and the abnormality detector 24 of the IMU 2c determines that the measurement value of the X-axis acceleration contained in the matched data ALD3 output from the communication interface circuit 31 of the IMU 2g is abnormal. In this case, the combining processor 23 of each of the IMUs 2b, 2c calculates the average value of the X-axis acceleration by adding the measurement values of the X-axis acceleration contained in the matched data ALD, ALD2, which are normal, and then dividing the result by 2, which is the number of normal data. Then, in each of the IMUs 2b, 2c, the communication interface circuit 31 transmits, to the communication interface circuit 32 of the IMU 2a, the measurement data DO obtained by adding the combined-item number information including the number (=2) of the measurement values of the triaxial acceleration used in the combining processing to the data generated by the combining processing. In the IMU 2a, when the abnormality detector 24 determines that the measurement values of the X-axis acceleration respectively contained in the matched data ALD, ALD2, and ALD3 are all normal, the combining processor 23 adds the measurement values of the X-axis acceleration contained in the matched data ALD, ALD2, and ALD3. That is, the combining processor 23 calculates an addition value of the five X-axis acceleration values measured by the IMUs 2a, 2b, 2c, 2d, and 2f. Further, the combining processor 23 specifies that the number of measurement values of the X-axis acceleration used in the combining processing is 5 based on the combined-item number information contained in each of the matched data ALD2, ALD3, and calculates an average value by dividing the addition value of the measurement values of the X-axis acceleration by 5. Then, the communication interface circuit 31 of the IMU 2a transmits, to the host device 3, the measurement data DO obtained by adding the combined-item number information including the number (=5) of measurement values of the triaxial acceleration used in the combining processing to the data generated by the combining processing.

Since the other configurations of the inertial sensor device 1 of the third embodiment are substantially the same as those of the first embodiment or the second embodiment, the description thereof will be omitted.

According to the inertial sensor device 1 of the third embodiment described above, when any one of the measurement data DO based on the output signals of the inertial sensors 10 of the respective IMUs 2a to 2g is abnormal, the IMU 2a performs the combining processing without using the abnormal data, and thus it is possible to suppress a decrease in the calculation accuracy of the combining processing. Further, according to the inertial sensor device 1 of the third embodiment, since the host device 3 can estimate the accuracy of the measurement data DO based on the combined-item number information, it is possible to perform appropriate processing based on the measurement data DO.

Besides the above, according to the inertial sensor device 1 of the third embodiment, substantially the same advantages as those of the inertial sensor device 1 of the first embodiment or the second embodiment can be obtained.

### 4. Modified Examples

The present disclosure is not limited to the present embodiments, and various modified implementations can be made within the scope of the gist of the present disclosure.

For example, in the inertial sensor device 1 of each of the embodiments described above, the number of IMUs coupled to the communication interface circuit 32 of each of the IMUs 2a, 2b, and 2c is not limited to 0 or 2, and may be 1. In addition, one or two IMUs may be coupled to each of the communication interface circuits 32 of the IMUs 2d, 2e, 2f, and 2g. That is, the number of IMUs provided to the inertial sensor device 1 is not particularly limited.

The embodiments and the modified examples described above are illustrative only, and the present disclosure is not limited thereto. For example, it is possible to appropriately combine the embodiments and the modified examples with each other.

The present disclosure includes substantially the same configurations as the configurations described in the embodiment, such as configurations having the same functions, methods, and results, or configurations having the same objects and advantages. Further, the present disclosure includes configurations obtained by replacing non-essential portions of the configurations described in the embodiments. Furthermore, the present disclosure includes configurations that exert the same functions and advantages or configurations that can achieve the same objects as those of the configurations described in the embodiments. Further, the present disclosure includes a configuration obtained by adding a known technique to the configurations described in the embodiments.

The following contents are derived from the embodiments and modified examples described above.

An aspect of an inertial sensor device is an inertial sensor device to be coupled to an external device, the inertial sensor device including a plurality of inertial measurement units, wherein each of the plurality of inertial measurement units includes an inertial sensor, a signal processor configured to process an output signal of the inertial sensor, a first communication unit, and a second communication unit, the plurality of inertial measurement units includes a first inertial measurement unit, a second inertial measurement unit, a third inertial measurement unit, and a fourth inertial measurement unit, the first communication unit of the first inertial measurement unit and the first communication unit of the second inertial measurement unit are coupled to the second communication unit of the third inertial measurement unit, the first communication unit of the third inertial measurement unit is coupled to the second communication unit of the fourth inertial measurement unit, the first communication unit of the fourth inertial measurement unit is coupled to the external device, the first communication unit of the first inertial measurement unit transmits a first signal output from the signal processor of the first inertial measurement unit to the second communication unit of the third inertial measurement unit, the first communication unit of the second inertial measurement unit transmits, to the second communication unit of the third inertial measurement unit, a second signal output from the signal processor of the second inertial measurement unit, the signal processor of the third inertial measurement unit performs a calculation on the first signal, the second signal, and a third signal that is an output signal of the inertial sensor of the third inertial measurement unit to output a fourth signal, the first communication unit of the third inertial measurement unit transmits the fourth signal to the second communication unit of the fourth inertial measurement unit, the signal processor of the fourth inertial measurement unit performs a calculation on the fourth signal and a fifth signal that is an output signal of the inertial sensor of the fourth inertial measurement unit to output a sixth signal, and the first communication unit of the fourth inertial measurement unit transmits the sixth signal to the external device.

According to the present inertial sensor device, since the fourth inertial measurement unit performs the calculation using the first signal, the second signal, the third signal, and the fifth signal based on the output signals of the inertial sensors of the first inertial measurement unit, the second inertial measurement unit, the third inertial measurement unit, and the fourth inertial measurement unit, the calculation accuracy can be improved. Further, according to the inertial sensor device, since the first inertial measurement unit and the second inertial measurement unit are coupled in parallel to the third inertial measurement unit, an increase in processing time and communication time of the calculation is suppressed compared to when the first inertial measurement unit and the second inertial measurement unit are coupled in series to the third inertial measurement unit. Further, when the first inertial measurement unit and the second inertial measurement unit are coupled in series to the third inertial measurement unit, the first inertial measurement unit and the second inertial measurement unit become unavailable when the second inertial measurement unit breaks down, whereas according to the present inertial sensor device, when the first inertial measurement unit or the second inertial measurement unit breaks down, only the first inertial measurement unit or the second inertial measurement unit becomes unavailable, and thus it is possible to suppress a decrease in calculation accuracy.

In the aspect of the inertial sensor device, each of the plurality of inertial measurement units may include a controller, the controller of the first inertial measurement unit may generate first coupling information specifying a number of inertial measurement units coupled to the second communication unit of the first inertial measurement unit, the first communication unit of the first inertial measurement unit may transmit the first coupling information to the second communication unit of the third inertial measurement unit, the controller of the second inertial measurement unit may generate second coupling information specifying a number of inertial measurement units coupled to the second communication unit of the second inertial measurement unit, the first communication unit of the second inertial measurement unit may transmit the second coupling information to the second communication unit of the third inertial measurement unit, the controller of the third inertial measurement unit may generate third coupling information specifying a number of inertial measurement units coupled to the second communication unit of the third inertial measurement unit based on the first coupling information and the second coupling information, the first communication unit of the third inertial measurement unit may transmit the third coupling information to the second communication unit of the fourth inertial measurement unit, the controller of the fourth inertial measurement unit may generate fourth coupling information specifying a number of inertial measurement units coupled to the second communication unit of the fourth inertial measurement unit based on the third coupling information, and the signal processor of the fourth inertial measurement unit may perform the calculation based on the fourth coupling information.

According to the present inertial sensor device, since the first inertial measurement unit and the second inertial measurement unit respectively transmit the first coupling information and the second coupling information to the third inertial measurement unit, and the third inertial measurement unit transmits the third coupling information generated based on the first coupling information and the second coupling information to the fourth inertial measurement unit, the fourth inertial measurement unit can recognize the number of inertial measurement units coupled to the external device based on the third coupling information to generate the fourth coupling information, and perform an appropriate calculation in accordance with the fourth coupling information. Further, in the inertial sensor device, since the fourth coupling information is obtained by the communication of the first inertial measurement unit, the second inertial measurement unit, the third inertial measurement unit, and the fourth inertial measurement unit, it is not necessary to store the fourth coupling information in the nonvolatile memory of the fourth inertial measurement unit in advance. Therefore, according to the present inertial sensor device, it is possible to reduce the production cost and to realize high expandability since it is easy to increase or decrease the number of inertial measurement units.

In the aspect of the inertial sensor device, the first communication unit of the fourth inertial measurement unit may transmit the fourth coupling information to the external device.

According to the present inertial sensor device, since the external device can recognize the number of inertial measurement units coupled to the external device itself based on the fourth coupling information, the external device can appropriately process the sixth signal in accordance with the number of units coupled thereto. Further, according to the inertial sensor device, since it is not necessary to store the fourth coupling information in the nonvolatile memory of the external device in advance, it is possible to improve flexibility and extensibility of the system construction.

In the aspect of the inertial sensor device, when the first communication unit of the fourth inertial measurement unit receives an initial setting command from the external device, the second communication unit of the fourth inertial measurement unit may transmit a command for performing initial setting of the third inertial measurement unit to the first communication unit of the third inertial measurement unit, and the second communication unit of the third inertial measurement unit may transmit a command for performing initial setting of the first inertial measurement unit to the first communication unit of the first inertial measurement unit and transmit a command for performing initial setting of the second inertial measurement unit to the first communication unit of the second inertial measurement unit.

In the present inertial sensor device, since the initial setting of the first inertial measurement unit, the second inertial measurement unit, the third inertial measurement unit, and the fourth inertial measurement unit is performed by the initial setting command transmitted from the external device, it is not necessary to store the initial setting information in advance in the non-volatile memories of the first inertial measurement unit, the second inertial measurement unit, the third inertial measurement unit, and the fourth inertial measurement unit. Therefore, according to the present inertial sensor device, the production cost can be reduced, and the flexibility and expandability of the system construction can be improved.

In the aspect of the inertial sensor device, the signal processor of the third inertial measurement unit may perform predetermined processing on the third signal to generate a seventh signal, determine whether the first signal, the second signal, and the seventh signal are normal or abnormal, and perform combining processing using any signals determined to be normal out of the first signal, the second signal, and the seventh signal to output the fourth signal, and the first communication unit of the third inertial measurement unit may transmit, to the second communication unit of the fourth inertial measurement unit, combined-item number information specifying a number of signals used in the combining processing together with the fourth signal.

According to the present inertial sensor device, a noise component contained in the fourth signal can be reduced by the combining processing of the first signal, the second signal, and the seventh signal, and when any one of the first signal, the second signal, and the seventh signal is abnormal, the combining processing is performed without using the abnormal signal, and thus, it is possible to suppress a decrease in calculation accuracy of the combining processing. Further, when the first inertial measurement unit and the second inertial measurement unit are coupled in series to the third inertial measurement unit, when the second inertial measurement unit breaks down, the first inertial measurement unit and the second inertial measurement unit become unavailable, and the effect of reducing the noise component by the combining processing is significantly reduced, whereas according to the present inertial sensor device, when the first inertial measurement unit or the second inertial measurement unit breaks down, only the first inertial measurement unit or the second inertial measurement unit becomes unavailable, and thus it is possible to reduce a deterioration in the effect of reducing the noise component by the combining processing.

Another aspect of the inertial sensor device is an inertial sensor device to be coupled to an external device, the inertial sensor device including a plurality of inertial measurement units, wherein each of the plurality of inertial measurement units includes an inertial sensor, a signal processor configured to process an output signal of the inertial sensor, a first communication unit, and a second communication unit, the plurality of inertial measurement units includes a first inertial measurement unit, a second inertial measurement unit, and a third inertial measurement unit, the first communication unit of the first inertial measurement unit and the first communication unit of the second inertial measurement unit are coupled to the second communication unit of the third inertial measurement unit, the first communication unit of the third inertial measurement unit is coupled to the external device, the first communication unit of the first inertial measurement unit transmits a first signal output from the signal processor of the first inertial measurement unit to the second communication unit of the third inertial measurement unit, the first communication unit of the second inertial measurement unit transmits a second signal output from the signal processor of the second inertial measurement unit to the second communication unit of the third inertial measurement unit, the signal processor performs a calculation on the first signal, the second signal, and a third signal that is an output signal of the inertial sensor of the third inertial measurement unit to output a fourth signal, and the first communication unit of the third inertial measurement unit transmits the fourth signal to the external device.

According to the present inertial sensor device, since the third inertial measurement unit performs the calculation using the first signal, the second signal, and the third signal based on the respective output signals of the inertial sensors of the first inertial measurement unit, the second inertial measurement unit, and the third inertial measurement unit, the calculation accuracy can be improved. Further, according to the inertial sensor device, since the first inertial measurement unit and the second inertial measurement unit are coupled in parallel to the third inertial measurement unit, an increase in processing time and communication time of the calculation is suppressed compared to when the first inertial measurement unit and the second inertial measurement unit are coupled in series to the third inertial measurement unit. Further, when the first inertial measurement unit and the second inertial measurement unit are coupled in series to the third inertial measurement unit, the first inertial measurement unit and the second inertial measurement unit become unavailable when the second inertial measurement unit breaks down, whereas according to the present inertial sensor device, when the first inertial measurement unit or the second inertial measurement unit breaks down, only the first inertial measurement unit or the second inertial measurement unit becomes unavailable, and thus it is possible to suppress a decrease in calculation accuracy.

In the aspect of the inertial sensor device, each of the plurality of inertial measurement units may include a controller, the controller of the first inertial measurement unit may generate first coupling information specifying a number of inertial measurement units coupled to the second communication unit of the first inertial measurement unit, the first communication unit of the first inertial measurement unit may transmit the first coupling information to the second communication unit of the third inertial measurement unit, the controller of the second inertial measurement unit may generate second coupling information specifying a number of inertial measurement units coupled to the second communication unit of the second inertial measurement unit, the first communication unit of the second inertial measurement unit may transmit the second coupling information to the second communication unit of the third inertial measurement unit, the controller of the third inertial measurement unit may generate third coupling information specifying a number of inertial measurement units coupled to the external device based on the first coupling information and the second coupling information, and the signal processor of the third inertial measurement unit may perform the calculation based on the third coupling information.

According to the present inertial sensor device, since the first inertial measurement unit and the second inertial measurement unit respectively transmit the first coupling information and the second coupling information to the third inertial measurement unit, the third inertial measurement unit can recognize the number of inertial measurement units coupled to the external device based on the first coupling information and the second coupling information to generate the third coupling information, and perform an appropriate calculation in accordance with the third coupling information. Further, in the inertial sensor device, since the third coupling information is obtained by the communication of the first inertial measurement unit, the second inertial measurement unit, and the third inertial measurement unit, it is not necessary to store the third coupling information in the nonvolatile memory of the third inertial measurement unit in advance. Therefore, according to the present inertial sensor device, it is possible to reduce the production cost and to realize high expandability since it is easy to increase or decrease the number of inertial measurement units.

In the aspect of the inertial sensor device, the first communication unit of the third inertial measurement unit may transmit the third coupling information to the external device.

According to the present inertial sensor device, since the external device can recognize the number of inertial measurement units coupled to the external device itself based on the third coupling information, the external device can appropriately process the fourth signal in accordance with the number of units coupled thereto. Further, according to the inertial sensor device, since it is not necessary to store the third coupling information in the nonvolatile memory of the external device in advance, it is possible to improve flexibility and extensibility of the system construction.

In the aspect of the inertial sensor device, when the first communication unit of the third inertial measurement unit receives an initial setting command from the external device, the second communication unit of the third inertial measurement unit may transmit a command for performing initial setting of the first inertial measurement unit to the first communication unit of the first inertial measurement unit and transmit a command for performing initial setting of the second inertial measurement unit to the first communication unit of the second inertial measurement unit.

In the present inertial sensor device, since the initial setting of the first inertial measurement unit, the second inertial measurement unit, and the third inertial measurement unit is performed by the initial setting command transmitted from the external device, it is not necessary to store the initial setting information in advance in the non-volatile memories of the first inertial measurement unit, the second inertial measurement unit, and the third inertial measurement unit. Therefore, according to the present inertial sensor device, the production cost can be reduced, and the flexibility and expandability of the system construction can be improved.

In the aspect of the inertial sensor device, the signal processor of the third inertial measurement unit may perform predetermined processing on the third signal to generate a fifth signal, determine whether the first signal, the second signal, and the fifth signal are normal or abnormal, and perform combining processing using any signals determined to be normal out of the first signal, the second signal, and the fifth signal to output the fourth signal, and the first communication unit of the third inertial measurement unit may transmit, to the external device, combined-item number information specifying a number of signals used in the combining processing together with the fourth signal.

According to the present inertial sensor device, a noise component contained in the fourth signal can be reduced by the combining processing of the first signal, the second signal, and the fifth signal, and when any one of the first signal, the second signal, and the fifth signal is abnormal, the combining processing is performed without using the abnormal signal, and thus, it is possible to suppress a decrease in calculation accuracy of the combining processing. Further, when the first inertial measurement unit and the second inertial measurement unit are coupled in series to the third inertial measurement unit, when the second inertial measurement unit breaks down, the first inertial measurement unit and the second inertial measurement unit become unavailable, and the effect of reducing the noise component by the combining processing is significantly reduced, whereas according to the present inertial sensor device, when the first inertial measurement unit or the second inertial measurement unit breaks down, only the first inertial measurement unit or the second inertial measurement unit becomes unavailable, and thus it is possible to reduce a deterioration in the effect of reducing the noise component by the combining processing. Further, according to the present inertial sensor device, since the external device can estimate the accuracy of the measurement data based on the combined-item number information, it is possible to perform appropriate processing based on the measurement data.

What is claimed is:

1. An inertial sensor device to be coupled to an external device, the inertial sensor device comprising
a plurality of inertial measurement units, wherein
each of the plurality of inertial measurement units includes
an inertial sensor,
a signal processor configured to process an output signal of the inertial sensor,
a first communication unit, and
a second communication unit,
the plurality of inertial measurement units includes a first inertial measurement unit, a second inertial measurement unit, a third inertial measurement unit, and a fourth inertial measurement unit,
the first communication unit of the first inertial measurement unit and the first communication unit of the second inertial measurement unit are coupled to the second communication unit of the third inertial measurement unit,
the first communication unit of the third inertial measurement unit is coupled to the second communication unit of the fourth inertial measurement unit,
the first communication unit of the fourth inertial measurement unit is coupled to the external device,
the first communication unit of the first inertial measurement unit transmits a first signal output from the signal processor of the first inertial measurement unit to the second communication unit of the third inertial measurement unit,
the first communication unit of the second inertial measurement unit transmits, to the second communication unit of the third inertial measurement unit, a second signal output from the signal processor of the second inertial measurement unit,
the signal processor of the third inertial measurement unit performs a calculation on the first signal, the second signal, and a third signal that is an output signal of the inertial sensor of the third inertial measurement unit to output a fourth signal,
the first communication unit of the third inertial measurement unit transmits the fourth signal to the second communication unit of the fourth inertial measurement unit,
the signal processor of the fourth inertial measurement unit performs a calculation on the fourth signal and a fifth signal that is an output signal of the inertial sensor of the fourth inertial measurement unit to output a sixth signal, and
the first communication unit of the fourth inertial measurement unit transmits the sixth signal to the external device.

2. The inertial sensor device according to claim 1, wherein
each of the plurality of inertial measurement units includes a controller,
the controller of the first inertial measurement unit generates first coupling information specifying a number of inertial measurement units coupled to the second communication unit of the first inertial measurement unit,
the first communication unit of the first inertial measurement unit transmits the first coupling information to the second communication unit of the third inertial measurement unit,
the controller of the second inertial measurement unit generates second coupling information specifying a number of inertial measurement units coupled to the second communication unit of the second inertial measurement unit,
the first communication unit of the second inertial measurement unit transmits the second coupling information to the second communication unit of the third inertial measurement unit,
the controller of the third inertial measurement unit generates third coupling information specifying a number of inertial measurement units coupled to the second communication unit of the third inertial measurement unit based on the first coupling information and the second coupling information,
the first communication unit of the third inertial measurement unit transmits the third coupling information to the second communication unit of the fourth inertial measurement unit,
the controller of the fourth inertial measurement unit generates fourth coupling information specifying a number of inertial measurement units coupled to the second communication unit of the fourth inertial measurement unit based on the third coupling information, and
the signal processor of the fourth inertial measurement unit performs the calculation based on the fourth coupling information.

3. The inertial sensor device according to claim 2, wherein
the first communication unit of the fourth inertial measurement unit transmits the fourth coupling information to the external device.

4. The inertial sensor device according to claim 1, wherein
when the first communication unit of the fourth inertial measurement unit receives an initial setting command from the external device,
the second communication unit of the fourth inertial measurement unit transmits a command for performing initial setting of the third inertial measurement unit to the first communication unit of the third inertial measurement unit, and
the second communication unit of the third inertial measurement unit transmits a command for performing initial setting of the first inertial measurement unit to the first communication unit of the first inertial measurement unit and transmits a command for performing initial setting of the second inertial measurement unit to the first communication unit of the second inertial measurement unit.

5. The inertial sensor device according to claim 1, wherein
the signal processor of the third inertial measurement unit is configured to
perform predetermined processing on the third signal to generate a seventh signal,
determine whether the first signal, the second signal, and the seventh signal are normal or abnormal, and
perform combining processing using any signals determined to be normal out of the first signal, the second signal, and the seventh signal to output the fourth signal, and
the first communication unit of the third inertial measurement unit is configured to transmit, to the second communication unit of the fourth inertial measurement unit, combined-item number information specifying a number of signals used in the combining processing together with the fourth signal.

6. An inertial sensor device to be coupled to an external device, the inertial sensor device comprising
a plurality of inertial measurement units, wherein
each of the plurality of inertial measurement units includes
an inertial sensor,
a signal processor configured to process an output signal of the inertial sensor,
a first communication unit, and
a second communication unit,
the plurality of inertial measurement units includes a first inertial measurement unit, a second inertial measurement unit, and a third inertial measurement unit,
the first communication unit of the first inertial measurement unit and the first communication unit of the second inertial measurement unit are coupled to the second communication unit of the third inertial measurement unit,
the first communication unit of the third inertial measurement unit is coupled to the external device,
the first communication unit of the first inertial measurement unit transmits a first signal output from the signal processor of the first inertial measurement unit to the second communication unit of the third inertial measurement unit,
the first communication unit of the second inertial measurement unit transmits a second signal output from the signal processor of the second inertial measurement unit to the second communication unit of the third inertial measurement unit,
the signal processor performs a calculation on the first signal, the second signal, and a third signal that is an output signal of the inertial sensor of the third inertial measurement unit to output a fourth signal, and
the first communication unit of the third inertial measurement unit transmits the fourth signal to the external device.

7. The inertial sensor device according to claim 6, wherein
each of the plurality of inertial measurement units includes a controller,
the controller of the first inertial measurement unit generates first coupling information specifying a number of inertial measurement units coupled to the second communication unit of the first inertial measurement unit,
the first communication unit of the first inertial measurement unit transmits the first coupling information to the second communication unit of the third inertial measurement unit,
the controller of the second inertial measurement unit generates second coupling information specifying a number of inertial measurement units coupled to the second communication unit of the second inertial measurement unit,
the first communication unit of the second inertial measurement unit transmits the second coupling information to the second communication unit of the third inertial measurement unit,
the controller of the third inertial measurement unit generates third coupling information specifying a number of inertial measurement units coupled to the external device based on the first coupling information and the second coupling information, and
the signal processor of the third inertial measurement unit performs the calculation based on the third coupling information.

8. The inertial sensor device according to claim 7, wherein
the first communication unit of the third inertial measurement unit transmits the third coupling information to the external device.

9. The inertial sensor device according to claim 6, wherein
when the first communication unit of the third inertial measurement unit receives an initial setting command from the external device,
the second communication unit of the third inertial measurement unit transmits a command for performing initial setting of the first inertial measurement unit to the first communication unit of the first inertial measurement unit and transmits a command for performing initial setting of the second inertial measurement unit to the first communication unit of the second inertial measurement unit.

10. The inertial sensor device according to claim 6, wherein
the signal processor of the third inertial measurement unit is configured to
perform predetermined processing on the third signal to generate a fifth signal,
determine whether the first signal, the second signal, and the fifth signal are normal or abnormal, and
perform combining processing using any signals determined to be normal out of the first signal, the second signal, and the fifth signal to output the fourth signal, and
the first communication unit of the third inertial measurement unit is configured to transmit, to the external device, combined-item number information specifying a number of signals used in the combining processing together with the fourth signal.
